(19) United States
(12) Patent Application Publication
(10) Pub. No.: US 2020/0215846 A1
(43) Pub. Date: Jul. 9, 2020

(54) DOCUMENT, METHOD FOR PRODUCING A DOCUMENT, AND A DEVICE FOR CARRYING OUT THE METHOD

(71) Applicant: LEONHARD KURZ Stiftung & Co. KG, Fürth (DE)

(72) Inventors: Marco Ordung, Heilsbronn (DE); Klaus Pforte, Oberasbach (DE); Thorsten Schaller, Nürnberg (DE); Jochen Wening, Oberasbach (DE)

(21) Appl. No.: 16/637,515

(22) PCT Filed: Jul. 27, 2018
(86) PCT No.: PCT/EP2018/070506

§ 371 Date: Feb. 7, 2020

(30) Foreign Application Priority Data
Aug. 15, 2017 (DE) 10 2017 118 579.8

(51) Int. Cl. B42D 25/435; B42D 25/425; B42D 25/45; B42D 25/328; B42D 25/346; B42D 25/351; B42D 25/378

(52) U.S. Cl. CPC B42D 25/435; B42D 25/425; B42D 25/45; B42D 25/378; B42D 25/346; B42D 25/351; B42D 25/328

(57) ABSTRACT

A document, a method for producing a document, and a device for carrying out the method. The document, in particular a banknote, an identity document, a visa or a security, here includes a carrier substrate and a decorative ply, wherein the single- or multi-layered carrier substrate has an upper side and an underside, and the decorative ply is applied to the upper side of the carrier substrate, and wherein at least one layer of the carrier substrate is perforated in one or more first regions by means of a laser such that the decorative ply is visible in the one or more first regions when the document is viewed from the underside of the carrier substrate.

The invention relates to a document, a method for producing a document, and a device for carrying out the method.

Documents, in particular security documents, are widespread in many areas of the public, state and private sectors. Documents such as, for instance, banknotes, passports, ID cards, bank cards, credit cards, visas or certificates often have window regions, in which security elements are arranged which can be viewed in reflected light and/or transmitted light, in order to increase the protection against forgery. To produce such window regions, perforations are typically first introduced into the carrier substrate by means of stamping, which are then covered by a film having the corresponding security elements. As an alternative to introducing the perforations by means of stamping, cutting processes, such as for example water jet cutting, are also used. It is common to all of the known methods for producing the window regions that the removed part of the carrier substrate, which forms the window region, is left behind as residue or waste. Not only does this result in waste, but this waste has to be collected and disposed of, often expensively, as there are corresponding requirements for carrier substrates from the security field in particular, which mandate disposal without reusable residues, such as for example incineration.

Thus, DE 43 34 847 A1 discloses generating a perforation by means of stamping or cutting methods in a value document, wherein for example laser cutting can be used as cutting method.

EP 2 533 982 B1 describes a security element for a value document which comprises a series of openings, wherein the arrangement of the openings forms a data element. The openings are generated by laser perforation.

The object of the invention is now to provide an improved document, and an improved method for producing a document.

This object is achieved by a document, in particular a banknote, an identity document, a visa or a security, comprising a carrier substrate and a decorative ply, wherein the single- or multi-layered carrier substrate has an upper side and an underside, and the decorative ply is applied to the upper side of the carrier substrate, and wherein at least one layer of the carrier substrate is perforated in one or more first regions by means of a laser such that the decorative ply is visible in the one or more first regions when the document is viewed from the underside of the carrier substrate. This object is further achieved by a method for producing a document, in particular according to one of claims 1 to 25, comprising a carrier substrate with an upper side and an underside, wherein the method comprises the following steps, which are performed in particular in the following sequence; a) providing the carrier substrate; b) applying a decorative ply, in particular by means of hot stamping, cold stamping or laminating, to the upper side of the carrier substrate; c) perforating at least one layer of the carrier substrate in one or more first regions by means of a laser such that the applied decorative ply is visible in the one or more first regions when the document is viewed from the underside of the carrier substrate. This object is further achieved by a device for carrying out a method according to one of claims 25 to 42, comprising:—a transport device for transporting the carrier substrate;—a first application device for applying the decorative ply to the single- or multi-layered carrier substrate;—a first unit comprising a laser for perforating at least one layer of the carrier substrate, in particular in one or more first regions.

The steps of the method are preferably performed in the sequence a), b), c) or a), c), b). In particular, the steps of the method are performed in any desired sequence, wherein one or more of the steps c), a), b) are in particular preferably not performed, such as for example in the sequence a), c), c), and/or in particular preferably are performed multiple times, such as for example in the sequence a), b), b), c), c).

The carrier substrate can be formed single-layered or also multi-layered.

It has been shown here that a new and improved type of perforation is produced or provided in carrier substrates through the document according to the invention, through the method for producing a document and through the device for carrying out the method. Because the decorative ply is visible in the perforated regions from the back of the carrier substrate, particularly striking optical impressions and effects result for an observer because of the high contrast between the carrier substrate preferably formed matte and light and the decorative ply visible through the perforations. The document further makes it possible for features present in the decorative ply, in particular existing, roughly prestructured features, to become apparent in a particularly eye-catching manner because of the design of the perforated regions. The method further makes it possible to introduce the perforations into the carrier substrate after application of the decorative layer. It is hereby made possible to introduce closed outer contours, without the perforated region falling off or out, since the decorative ply fixes it in place. On the one hand, waste is hereby prevented and, on the other hand, novel perforations or window regions are hereby made possible. The applied decorative ply further has a stabilizing action overall, in particular for a perforation of the carrier substrate following the application of the decorative ply.

The term document also includes possible uses of the carrier substrate as packaging, part of a packaging, labels or also other uses in which a formation of perforations is useful and makes sense. The carrier substrate can thus be a packaging, part of a packaging, a carrier ply or another layer of a label or a layer of a badge, a sleeve or the like. In particular, such a label, badge, sleeve can then be applicable to a further substrate, for example as a tax stamp, tax strip, seal, token, tag.

The terms upper side and/or underside here serve in particular to distinguish between the surfaces of the carrier substrate and in particular represent a frame of reference. However, it is also possible, instead of these terms of reference, to use the terms first side and second side.

By region is meant here in each case a defined surface area of a layer or ply which is occupied when viewed perpendicular to a plane spanned by the carrier substrate. Thus, for example, the carrier substrate has one or more first regions, wherein each of the regions in each case occupies a defined surface area when viewed perpendicular to a plane spanned by the carrier substrate.

By perforation of a layer is meant here the complete removal of a layer, in particular by means of laser cutting and/or laser ablation. If, for example, a layer is perforated in a region, the corresponding layer is completely removed in this region. The perforation here is preferably effected using laser cutting and/or laser ablation, with the result that the perforated layers are worn away and/or ablated and/or burnt up and/or evaporated residue-free in the corresponding regions. Thus, for example, the at least one layer is completely removed in the one or more first regions, in particular by means of laser cutting and/or laser ablation, with the result that the at least one layer is worn away residue-free in the one or more first regions.

Preferably, one or more of the first and/or second regions are incompletely worn away or perforated directly thereafter or in a further step, with the result that an engraving or a type of engraving forms in the carrier substrate, which can be combined with the rest of the design of the carrier substrate.

Because of this perforation or complete removal of the corresponding layers it is made possible that no residue or waste is left behind, since the perforated or completely removed regions are instead ablated and/or burnt up and/or evaporated because of the residue-free lasering. On the one hand, already, no waste accumulates hereby and on the other hand the expensive disposal thereof with the associated outlay on corresponding protocolling and safeguarding is avoided, whereby the production costs can be reduced. Furthermore, because of this perforation or complete removal, in particular there remain no residues or burrs of the carrier substrate, which can lead to problems, such as impurities, in the further machining process, in particular because of the typically high running speed of the carrier substrate during the machining. Wastage is hereby reduced.

In particular, local combustion processes result at the site of action of the laser energy during the lasering in the case of carrier substrates made of paper. It is advantageous to extract the gaseous and/or dusty smoke gases forming in the process quickly and as completely as possible with at least one extraction device and/or to blow these gases away with at least one blower device, in order to prevent dirt, such as for example soot, from depositing on the carrier substrate due to these smoke gases and arising disadvantageously in possible subsequent method steps.

Preferably, the extraction of the smoke gases is effected in a chamber in which the lasering is also effected. In particular, several chambers are connected to each other, wherein lasering is effected in one or more of the connected chambers. The chamber or one or more or all of the connected chambers are preferably self-contained, wherein preferably no exchange of air and/or gases takes place between the chamber or the connected chambers and the outside world. The chamber has in particular at least one viewing window. The extraction is preferably effected in a targeted manner in the chamber, with the result that there is no need for very high suction powers. Furthermore, in the case of an extraction inside the chamber, the risk is reduced that foreign bodies of widely different sizes, which in particular impede the lasering and/or other method steps, will also be sucked in during the extraction.

By visible is meant here that the decorative layer s recognizable for an observer when the document is viewed by the naked human eye, in particular by a sensor or a sensor unit when the document is captured, from the underside of the carrier substrate.

Further advantageous embodiments of the invention are described in the dependent claims.

It is advantageous if the decorative ply in the one or more first regions at least on the side facing the carrier substrate and/or also on the side facing away from the carrier substrate defines and/or predetermines optical effects perceptible for an observer, in particular optically variable effects, which are visible when the document is viewed from the underside of the carrier substrate. Through its design the decorative ply thus defines the optical effects visible to an observer from the underside of the carrier substrate in the uncovered one or more first regions. In the regions that are not uncovered of the side of the decorative ply facing the carrier substrate, the optical effects are covered by the carrier substrate and are thereby not or are only faintly optically active.

Preferably, the upper sides and/or the underside of the carrier substrate in each case provide one or more optical and/or optically variable effects which are detectable for an observer or a sensor or a sensor unit, wherein one or more of the optical or optically variable effects provide different colors, and wherein in particular at least one of the optical or optically variable effects is provided in the at least one uncovered first region.

For example, an observer can detect a surprising two- or multi-colored optical effect when the document is viewed, wherein the upper side of the carrier substrate provides a colored optical effect in a first color, for example blue, and on the underside of the carrier substrate provides a further optical effect in a second color, for example green, and wherein the further optical effect would not be detectable for the observer without the uncovered first region or the uncovered first regions.

The carrier substrate is expediently a paper substrate, in particular a single-layered paper substrate. It is also possible for the carrier substrate to comprise cotton fibers, wood fibers, pulp fibers, textile fibers and/or plastic fibers. Such carrier substrates can be removed residue-free by means of a laser, in particular by local combustion or evaporation.

It is further also possible for the carrier substrate to comprise one or more, in particular transparent, plastic plies, which are arranged on the upper side and/or underside of the carrier substrate, wherein in particular at least the one or more, in particular transparent, plastic plies arranged on the underside of the carrier substrate are perforated in the one or more first regions by means of the laser. It is hereby guaranteed that the decorative ply is visible in the one or more first regions when the document is viewed from the underside of the carrier substrate.

It is advantageous if the plastic plies cover a larger surface area than the decorative ply and overlap and/or overhang the decorative ply. If the decorative ply is designed in strip form, it is advantageous if the plastic plies overhang the decorative ply on both long sides. If the decorative ply is designed in patch form, it is advantageous if the plastic plies overhang the decorative ply on all sides. It is also advantageous if the plastic plies cover the one or more first and/or second and/or third regions completely and/or overhang the one or more first and/or second and/or third regions on all sides.

Thus, it is also possible for the method further to comprise the following step, which is carried out in particular before step b) and/or c):—applying one or more, in particular transparent, plastic plies, which are applied in particular to the upper side and/or underside of the carrier substrate. The one or more first regions, in which the at least one layer of the carrier substrate is perforated, can hereby be sealed, with the result that for example no impurities can enter the uncovered regions.

The carrier substrate is advantageously a multi-layered hybrid substrate which has one or more paper plies and one or more plastic plies, wherein in particular the one or more paper plies are perforated in the one or more first regions by means of the laser. This makes it possible for the decorative ply to be visible in the one or more first regions when the document is viewed from the underside of the carrier substrate.

It is also possible for the carrier substrate to be a multi-layered polymer substrate which has a transparent plastic ply and one or more opaque layers, wherein in particular the one or more opaque layers are perforated in the one or more first regions by means of the laser. This too makes it possible for the decorative ply to be visible in the one or more first regions when the document is viewed from the underside of the carrier substrate.

The carrier substrate preferably has a layer thickness between 30 μm and 250 μm, preferably between 50 μm and 100 μm. Such layer thicknesses can be perforated well by means of a laser, with the result that on the one hand a residue-free removal and on the other hand delicate perforations are guaranteed.

It is advantageous if the carrier substrate has additives, in particular security fibers and/or security pigments and/or dyes.

It is also possible for at least one layer of the carrier substrate to be perforated in one or more second regions by means of the laser such that the decorative ply is visible in the one or more second regions when the document is viewed from the underside of the carrier substrate, in particular wherein the one or more second regions have a different pattern from the one or more first regions and/or a different contour and/or a different code.

Thus, it is further possible for the method further to comprise the following step, which is carried out in particular before step b): d) perforating at least one layer of the carrier substrate in one or more second regions by means of a laser such that the decorative ply is visible in the one or more second regions when the document is viewed from the underside of the carrier substrate.

In particular, different motifs and/or patterns can be generated hereby, which are visible from the underside of the carrier substrate, with the result that the strikingness and thus the protection against forgery of the document is further increased hereby.

Here too, it is advantageous if the decorative ply in the one or more second regions at least on the side facing the carrier substrate and/or also on the free side facing away from the carrier substrate defines and/or predetermines optical effects perceptible for an observer, in particular optically variable effects, which are visible when the document is viewed from the underside of the carrier substrate. Through its design the decorative ply thus defines the optical effects visible to an observer from the underside of the carrier substrate in the uncovered one or more second regions. In the not uncovered regions of the side of the decorative ply facing the carrier substrate the optical effects are preferably covered by the carrier substrate and are thereby not or are only faintly optically active.

It is further possible for the one or more first regions to be connected to the one or more second regions and/or to overlap at least in regions.

The carrier substrate is advantageously completely perforated in the one or more first and/or second regions. Thus, it is also possible for the carrier substrate to be completely perforated in the one or more first and/or second regions in step c) and/or d).

According to a further embodiment example of the invention, each of the one or more first and/or second regions lies within a predefined region of surface, wherein each of the one or more first and/or second regions comprises in particular at most 25%, preferably at most 10%, of the surface area of the respective predefined region of surface or of the surface area of the respective document when viewed perpendicular to a plane spanned by the carrier substrate. The predefined region of surface comprises in particular a partial surface area or the entire surface area of the document.

For example, one of the lateral dimensions of the predefined region of surface corresponds to the height of the document, in particular the height of a banknote, and a further lateral dimension is freely chosen.

By predefined is meant here a predetermined value or range of values or a predetermined shape or geometry which comprises in particular 100% of the surface area. Thus, for example, a predefined region of surface is determined by a rectangle with a particular surface coverage. This region of surface preferably corresponds to 100%, with the result that in particular at most 25%, preferably at most 10%, of this predefined region of surface is removed by perforations in the one or more first and/or second regions.

Particularly striking optical effects can be generated hereby, as a high contrast between the carrier substrate and the decorative layer visible through the one or more first and/or second regions results because of the small surface coverage of the one or more first and/or second regions.

It is further advantageous if the width, in particular the line width, and/or the diameter of the one or more first regions and/or second regions is at most 2 mm, preferably at most 1 mm, when viewed perpendicular to a plane spanned by the carrier substrate.

Thus it is also possible for the laser beam to be widened in step c) and/or d) by means of a lens system and/or by means of a laser marking head having more than one, preferably more than two movement axes, such that the beam diameter in the focal point is at most 2 mm, preferably at most 1 mm.

It hereby becomes possible to uncover roughly prestructured features on the underside of the decorative ply, such as for example colored surface areas or surface areas with optically variable effects, by means of delicate perforations in the carrier substrate. Particularly striking and high-contrast optical effects which are visible from the underside of the carrier substrate can be achieved by such an uncovering.

It is further expedient if the width, in particular the line width, and/or the diameter of the one or more first regions and/or second regions when viewed perpendicular to a plane spanned by the carrier substrate is chosen such that the decorative ply is visible to the human eye in the one or more first regions and/or second regions when the document is viewed from the underside of the carrier substrate, and/or the width, in particular the line width, and/or the diameter of the one or more first regions and/or second regions is at least 20 μm, preferably at least 50 μm, particularly preferably at least 100 μm, when viewed perpendicular to a plane spanned by the carrier substrate. For this purpose it is expedient that a laser with a beam diameter in the focal point of at least 20 μm, preferably at least 50 μm, particularly preferably at least 100 μm, is used in step c) and/or d).

It has been shown here that by means of such widths, in particular line widths, and/or diameters, on the one hand, the visibility of the decorative ply in the one or more first and/or second regions from the underside of the carrier substrate can be guaranteed and, on the other hand, particularly delicate perforations can be generated.

In one or more of the first and/or second and/or third regions, in particular in regions comprising the decorative layer, the document preferably provides a first optical effect, in particular a first optically variable effect, which in reflected light can be detected by a sensor unit and/or is visible to the human eye, and/or in one or more of the first and/or second and/or third regions, in particular in regions comprising the decorative layer, the document has at least one first transmittance, which in transmitted light can be detected by means of a sensor unit and/or is visible to the human eye, and in the regions outside the first and/or second and/or third regions, in particular in regions comprising the carrier film and the at least one decorative layer, preferably in regions comprising the unperforated carrier film and the at least one decorative layer, further preferably within the first and/or second and/or third regions, has at least one second transmittance or at least one further transmittance, wherein in transmitted light the at least one second transmittance or the at least one further transmittance can be detected by a sensor unit and/or is visible to the human eye, wherein the at least one first transmittance, the at least one second transmittance and/or the at least one further transmittance differ from each other at least partially or the at least one first transmittance, the at least one second transmittance and/or the at least one further transmittance are at least partially or completely identical.

One or more of the third regions preferably have at least one third transmittance, which differs from or is partially or completely identical to the at least one first and/or the at least one second transmittance and/or the at least one further transmittance.

In particular, the decorative ply and/or the carrier substrate and/or the document comprising the at least one decorative ply and the carrier substrate have locally different transmittances.

The sensor unit is preferably selected or combined from: camera, in particular camera comprising a CCD chip (CCD=“charge-coupled device”), an IR camera (IR=infrared), a UV camera (UV=ultraviolet), or a transition-edge sensor (TES).

By “transmittance” is preferably meant a measurement which indicates the transmitted portion of the electromagnetic waves or light, in particular infrared light and/or UV light, passing through regions of the document, in particular the first, second and/or third regions, in transmitted light.

The first and second transmittances preferably differ by at least 0.1%, in particular by at least 1%, preferably by at least 10%, in particular preferably by at least 25%, particularly preferably by at least 50%, and hereby in particular provide a contrast.

The delicate perforations represent an advantageous protection against forgery, in particular through the verifiability of the delicate perforations in reflected light and in transmitted light. The locally uncovered optical effects of the decorative ply are preferably verified in reflected light. In transmitted light the delicate perforations have a higher transmittance than in the neighboring regions in each case because of the locally absent carrier substrate there. This contrast between the delicate perforations, in which only the decorative ply is present, and the neighboring regions, in which the carrier substrate and the decorative ply are present, is then optically verifiable. Although a forger could simulate the optical effects in the delicate perforations in reflected light by means of finely printed metallic pigments or metal pigments or also by means of delicately applied hot-stamping films or cold-stamping films, the forgery would be recognizable in transmitted light, because there would now be a lower transmittance within the first and/or second and/or third regions or the delicate perforations, and in the authentic document there should be a higher transmittance within the first and/or second and/or third regions or the delicate perforations. This means that the delicate perforations appear comparatively dark in transmitted light in the forgery, but should be comparatively light in the authentic document.

It is further also possible to vary the beam diameter in the focal point in step c) and/or d) during the perforation of the at least one layer of the carrier substrate. Here, the focus of the laser is advantageously altered, in particular by means of a lens system and/or by means of a laser marking head having more than one, preferably more than two, movement axes. The widths, in particular the line widths, and/or diameters of the one or more first and/or second regions can be varied hereby.

According to a further embodiment example of the invention, at least one third region of the carrier substrate is cut out by means of stamping and/or by means of a laser, in particular such that the decorative ply in the at least one third region is visible when the document is viewed from the underside of the carrier substrate, in particular wherein the at least one third region has a surface area at least 4 times, preferably at least 8 times, further preferably at least 10 times, larger than the one or more first and/or second regions.

Thus it is possible for the method further to comprise the following step, which is carried out in particular before step b): e) cutting out at least one third region of the carrier substrate by means of stamping and/or by means of a laser, in particular such that the decorative ply is visible in the at least one third region when the document is viewed from the underside of the carrier substrate.

It is hereby possible for the decorative layer to be also visible in the at least one third region from the underside of the carrier substrate in addition to the one or more first and/or second regions. Because the at least one third region occupies a larger surface area than the in particular delicate one or more first and/or second regions, for example more extensive motifs in the at least one third region can be combined with delicate lines of the one or more first and/or second regions. Unlike in the one or more first and/or second regions, the carrier substrate is not perforated in the at least one third region, but instead is, for example, stamped, wherein however the stamped-out waste has to be extracted and disposed of. For example, the generation of windows by means of stamping and/or laser cutting can hereby be combined with the present invention.

It is also possible for the one or more first and/or second regions to be connected to the at least one third region and/or to overlap at least in regions.

It is advantageous if the one or more first and/or second regions are designed patterned, in particular as a graphic motif, alphanumeric, linear, punctiform and/or as machine-readable code. A pattern can be, for example, a graphically designed outline, a figurative representation, an image, a motif, a symbol, a logo, a portrait, an alphanumeric character, a text and/or the like or a combination of one or more of the above patterns.

It is advantageous if the one or more third regions are designed patterned, in particular as a graphic motif and/or as machine-readable code. A pattern can be, for example, a graphically designed outline, an outline of a figurative representation, a motif outline, a symbol outline, a logo outline, or the like.

The one or more first and/or second and/or third regions are preferably formed individualized and/or personalized, with the result that respectively adapted one or more first and/or second and/or third regions can be formed, for example, for each document and/or for each document sheet and/or for each document batch or for similar document groups.

Each document is preferably provided with at least one individualized first, second and/or third region, wherein in particular banknotes in each case have a first, second and/or third region, which has one or more random patterns. These patterns are, for example, calculated by means of a computer and/or calculated by means of at least one pseudorandom function, pseudorandom distribution, random function, and/or random distribution, and/or provided by a database and/or a cloud. For example, passport documents can be individualized, such that the at least one first, second and/or third region designed as a pattern provides the portrait of the passport document holder in each case. In particular, the patterns are composed of one or more of the first, second and/or third regions.

According to a further embodiment example of the invention, the one or more first regions are arranged in a line grid. Advantageously, the grid width of the line grid substantially corresponds to the layer thickness of the carrier substrate, and/or the grid width of the line grid is between 30 μm and 250 μm, preferably between 50 μm and 100 μm, further preferably between 70 μm and 90 μm. It can hereby be achieved that the decorative ply is visible to an observer depending on a lateral viewing angle. Thus, it is possible for example that the decorative ply is not visible to an observer, looking at the document at a lateral viewing angle greater than 35°, preferably greater than 25°. It is further possible to generate a color-change effect by means of a visibility of the decorative ply dependent on the viewing angle.

Preferred embodiments of the decorative ply are described in the following:

It is possible for the decorative ply to be formed single- or multi-layered.

It is also advantageous if the decorative ply is applied to the upper side of the carrier substrate in regions, wherein the decorative ply is preferably applied to the upper side of the carrier substrate in strip form, wherein the strip particularly preferably extends over the entire document from one of the document edges to the corresponding opposite document edge. In particular, the decorative ply is additionally or alternatively applied to the upper side of the carrier substrate in patch form, wherein the at least one patch covers a region of the carrier substrate delimited as desired. Several decorative plies present in regions are preferably provided on the carrier substrate, wherein the decorative plies are in particular preferably arranged all on the same side of the carrier substrate and/or in each case on different sides of the carrier substrate.

It is further advantageous if the decorative ply completely covers the one or more first and/or second and/or third regions when viewed perpendicular to a plane spanned by the carrier substrate. It can hereby be ensured that the decorative ply or the optical effects generated by the decorative ply are visible in all perforated regions from the underside of the carrier substrate. It is further possible for the decorative ply to completely cover the predefined regions of surface when viewed perpendicular to a plane spanned by the carrier substrate. It is also expedient if the decorative ply is applied in step b) such that the decorative ply completely covers the one or more first and/or second regions and/or third regions and/or the predefined regions of surface when viewed perpendicular to a plane spanned by the carrier substrate.

It is further possible for the decorative ply to cover the one or more first and/or second and/or third regions only in regions when viewed perpendicular to a plane spanned by the carrier substrate, wherein parts of the one or more first and/or second and/or third regions are uncovered and in particular form continuous holes in the carrier substrate which have a further optical effect, preferably a high transmittance, in transmitted light.

The decorative ply preferably has one or more color layers, one or more layers with optically variable pigments, one or more thin-film layer systems, one or more layers generating an optically variable effect, one or more layers with color pigments and/or dissolved dyes and/or one or more layers with microstructures. The layers advantageously generate at least one color effect in the range of the wavelengths visible to the human eye, in particular in one or more or in the entire wavelength range of from 400 nm to 800 nm, and/or in one or more further wavelength ranges, in particular in one or more or in the entire ultraviolet wavelength range and/or in one or more or in the entire infrared wavelength range when the document is viewed from the underside of the carrier substrate. Particularly striking optical effects, in particular optically variable effects, can be generated hereby, which in particular in combination with the high contrast between the matte carrier substrate and the visible one or more first and/or second regions when viewed from the underside of the carrier substrate serve to increase the recognizability, and thus the protection against forgery.

It is further possible for the decorative ply to have at least one first layer and one second layer and for the first layer to be arranged between the upper side of the carrier substrate and the second layer.

The first and second layers are preferably selected from the group one or more color layers, one or more layers with optically variable pigments, one or more thin-film layer systems, one or more layers generating an optically variable effect, one or more layers with color pigments and/or dissolved dyes and/or one or more layers with microstructures, in particular wherein the layers generate at least one color effect in the range of the wavelengths visible to the human eye, in particular in the wavelength range of from 400 nm to 800 nm, when the document is viewed from the underside of the carrier substrate.

It is advantageous here if the microstructures are selected from the group Kinegram®, holograms, blazed gratings, in particular asymmetrical sawtooth relief structures, diffraction structures, in particular linear sinusoidal diffraction gratings or crossed sinusoidal diffraction gratings or linear single- or multi-step rectangular gratings or crossed single- or multi-step rectangular gratings, mirror surfaces, micromirrors, microlenses, matte structures, in particular anisotropic or isotropic matte structures, or combinations of these structures.

The following combinations of first and second layers of the decorative ply are preferably expedient:
the first layer is a first layer generating an optically variable effect and the one second layer is a second layer generating an optically variable effect,
the first layer has a first microstructure, in particular a Kinegram®, and the second layer has a second microstructure, in particular a zero-order diffraction structure,
the first layer has a first microstructure, in particular a Kinegram®, and the second layer has a thin-film layer system,
the first layer is a first color layer and the second layer is a second color layer, wherein the first and the second color layers have different colors, in particular from the RGB color space (RGB—red, green, blue).

It is also possible for at least one layer of the decorative ply to be perforated in the one or more first and/or second and/or third regions by means of a laser. It is further possible for the at least one layer of the carrier substrate to be perforated in the one or more first regions by means of a laser such that the first layer is visible in the one or more first regions when the document is viewed from the underside of the carrier substrate, and for the at least one layer of the carrier substrate and the first layer of the decorative ply to be perforated in the one or more second regions by means of a laser such that the second layer is visible in the one or more second regions when the document is viewed from the underside of the carrier substrate.

Thus it is also possible for at least one layer of the decorative ply further to be perforated by means of the laser in step c), in particular for the decorative ply to have a first layer and a second layer and the first layer to be arranged between the upper side of the carrier substrate and the second layer, wherein the first layer of the decorative ply is perforated in step c) in the one or more first and/or second and/or third regions by means of the laser from the direction of the underside. It hereby becomes possible to make different optical impressions visible to an observer or to uncover them in the one or more first and/or second and/or third regions depending on the perforation of the layers of the carrier substrate and the decorative ply from the direction of the underside of the carrier substrate depending on the design of the decorative ply. Thus, for example, a first color impression can be generated in the first layer uncovered in a first region and a second color impression can be generated in a second region, with the result that for an observer, as a whole, a multi-colored motif is uncovered, which is visible from the underside of the carrier substrate. For example, such a multi-colored motif can be an emblem or a colored flower with green leaves.

The first layer is preferably arranged on the side of the decorative ply facing away from the carrier substrate and in particular provides optically variable effects towards this side. The second layer is preferably arranged on the side of the decorative ply facing the carrier substrate and there, preferably through corresponding uncovering in the first and/or second and/or third regions, in each case provides optical effects.

It is also possible for the first and second layers to be arranged on the side of the decorative ply facing the carrier substrate and for a third layer to be arranged on the side of the decorative ply facing away from the carrier substrate and to provide optically variable effects towards this side.

It is further possible for the decorative ply to comprise at least one reflective layer, in particular a metal layer and/or an HRI or LRI layer (HRI=high refractive index, LRI=low refractive index), at least in regions. The metal layer is preferably a metal layer made of chromium, aluminum, gold, copper, silver or an alloy of such metals, in particular which is vapor-deposited under vacuum in a layer thickness of from 0.01 μm to 0.15 μm. It is further also possible for the reflective layer to be formed by a transparent reflective layer, for example a thin or finely structured metallic layer or an HRI or LRI layer. Such a dielectric reflective layer consists for example of a vapor-deposited layer made of a metal oxide, metal sulfide, titanium oxide, etc. with a thickness of from 10 nm to 150 nm. It is also possible to use a combination of at least one metal layer and at least one dielectric reflective layer.

The decorative ply expediently comprises at least one carrier film, at least one primer layer, n particular at least one varnish layer, preferably at least one decorative layer, and/or at least one adhesion layer. The carrier film consists in particular of PET (=polyethylene terephthalate), PEN (=polyethylene naphthalate), PE (=polyethylene), PI=(polyimide), PP (=polypropylene), PC or PTFE (=polytetrafluoroethylene). The adhesion layer is preferably a hot- or cold-glue layer, which comprises in particular acrylates, PVC, polyurethane or polyester. The primer layer is a layer which preferably comprises acrylates, PVC, polyurethane or polyester.

It is further expedient if the decorative ply comprises an optical separation layer, in particular an optically nontransparent layer, which preferably separates the optical impressions and/or effects visible when the document is viewed from the upper side of the carrier substrate from the optical impressions and/or effects visible in the one or more first and/or second regions when the document is viewed from the underside of the carrier substrate. The optical separation layer can be, for example, an opaque metal layer and/or an opaque color layer.

It is further possible for the decorative ply to be transparent at least in regions. In particular, the one or more first and/or second regions can hereby be viewed in transmitted light when the document is viewed from the underside of the carrier substrate.

It is also expedient if the decorative ply is a transfer ply of a hot-stamping film or a cold-stamping film or if the decorative ply is a laminating film.

It is also preferred if the values for the tolerance between the position of the decorative ply and the position of the perforations in the one or more first and/or second regions and/or the at least one third region are between ±0.1 mm and ±2.0 mm, preferably between ±0.3 mm and ±1.5 mm. For this purpose, in step b) the application of a decorative ply to the single- or multi-layered carrier substrate is preferably effected depending on register marks, for example print marks and/or watermarks and/or control openings. It is further also expedient if in step c) the perforation of the at least one layer of the carrier substrate is effected depending on such register marks.

As an alternative to the above-described register-accurate application of the decorative ply, it is also possible to apply the decorative ply in any desired position relative to the perforations, thus to apply it “out-of-register”.

By register or registration, or register accuracy or registration accuracy, is meant a positional accuracy of two or more elements and/or layers relative to each other. The register accuracy is to vary within a predefined tolerance, which is to be as small as possible. At the same time, the register accuracy of several elements and/or layers relative to each other is an important feature for increasing the process reliability. The positionally accurate positioning can be effected in particular by means of sensory, preferably optically detectable, register marks or registration marks. These register marks or registration marks can either represent special separate elements or regions or layers or themselves be part of the elements or regions or layers to be positioned.

Thus it is also possible for step b) and/or step c) further to comprise the following steps:—detecting the position data of at least one security feature of the carrier substrate, in particular a watermark and/or a printed feature;—optionally correcting the detected position data by means of an algorithm to form corrected position data;—introducing the control openings into the carrier substrate on the basis of the detected position data, in particular on the basis of the corrected position data, in particular by means of a laser. It is further advantageous if step b) further comprises the following step:—stretching the decorative ply before application of the decorative ply to the carrier substrate, wherein the stretching of the decorative ply is between 0% and 10%, preferably between 0% and 5%.

In particular, when a defined partial region of the decorative ply is viewed, the decorative ply before the stretching has a length of this partial region of the decorative ply approximately 0% and 10%, preferably between 0% and 5%, smaller than the corresponding, assigned partial region of the carrier substrate, in order that there is a largely identical length of the partial regions of the decorative ply and of the carrier substrate after the stretching. In particular, this length can also be defined by means of motif spacings on the decorative ply and on the carrier substrate, wherein there is then a motif spacing on the decorative ply approximately 0% and 10%, preferably between 0% and 5%, smaller than that on the carrier substrate before the stretching. After the stretching, the two motif spacings preferably match or almost match.

It is hereby achieved that in particular the optical effects generated by the decorative ply in the one or more first and/or second and/or third regions are uncovered with a high degree of accuracy, as the decorative ply is applied with tolerance values that are as small as possible and/or the perforation of the at least one layer of the carrier substrate is effected with a high degree of accuracy.

Preferred embodiments of the method for producing a document are described in the following:

It is expedient if in step c) the perforation of the at least one layer of the carrier substrate is effected from the direction of the underside of the carrier substrate.

According to a further embodiment example of the invention, a gas laser, in particular a CO₂ laser, and/or a solid-state laser, in particular an Nd:YAG laser, is used in step c) and/or d).

The laser is preferably actuated by means of electrical signals which are generated by means of an electronic control. This electronic control in particular also predefines the motif shape of the perforations to be generated.

This electronic actuation makes individualized or personalized signals possible for the laser. The corresponding information for this can be provided for example by a database and/or a cloud. The database and/or the cloud can make it possible to check the individualized and/or personalized information on the document later.

Each document is preferably provided with at least one personalized or individualized first, second and/or third region, which is introduced into the document or a series of documents through the individualized or personalized signals for the laser. Such patterns are, for example, calculated by means of a computer and/or calculated by means of at least one pseudorandom function, pseudorandom distribution, random function, and/or random distribution. For example, passport documents can be personalized or individualized through personalized or individualized signals for the laser such that the at least one first, second and/or third region designed as a pattern comprises the portrait or the name of or other information about the passport holder in each case. In particular, the patterns are composed of one or more of the first, second and/or third regions, wherein each of the regions is in each case assigned one or more personalized or individualized signals for the laser.

It is advantageous here if the laser power in step c) and/or d) is at least 250 W, preferably at least 300 W, further preferably at least 350 W. It is further advantageous if the wavelength of the laser is between 9.35 μm and 10.25 μm.

It is also possible if the laser beam is deflected in step c) and/or d) by means of movable mirrors, in particular by means of a laser scanning module, along the one or more first and/or second regions of the carrier substrate. It further makes sense if the laser beam is deflected in step e) by means of movable mirrors, in particular by means of a laser scanning module, along the outer contour of the at least one third region of the carrier substrate.

It is also advantageous if at least two lasers are used in step c). The at least two lasers are preferably matched to each other such that the production process is shortened. It is further possible that a first laser perforates the at least one layer of the carrier substrate in the one or more first regions and a second laser perforates the at least one layer of the carrier substrate in the one or more second regions. Through this “connection in series” the writing speed can be further increased while at the same time generating for example two different or also identical motifs.

It is further possible for the two lasers to be arranged parallel to each other such that each laser in each case machines one track of the carrier substrate in the one or more first and/or second regions and thereby several perforations can be introduced into the carrier substrate in parallel.

It is further possible for the carrier substrate to be machined in at least one machining track or one panel in parallel, wherein the machining track or the panel is preferably in each case a partial surface area of the carrier substrate aligned and/or dimensioned as desired relative to the direction of travel of the substrate. The alignment of the machining tracks or panels preferably runs parallel to the direction of travel of the carrier substrate. One or more or all of the machining tracks preferably have at least two, particularly preferably a plurality of, panels.

One or more of the first, second and/or third regions are preferably perforated in each case in one or more of the machining tracks and/or one or more of the panels of the carrier substrate in parallel and/or at the same time by one or more lasers and/or by in each case one or more lasers.

For example, a carrier substrate can have five machining tracks, the maximum lateral extent of which in each case is aligned along the direction of travel of the carrier substrate and the widths of the machining tracks transverse or perpendicular to the direction of travel of the substrate are preferably the same. Each of the machining tracks can have a plurality of panels for example along the direction of travel of the carrier substrate. Each of the machining tracks can be assigned for example in each case to three lasers, with the result that with a total of five machining tracks a total of 15 lasers are provided, wherein in the case of three lasers assigned to one of the machining tracks machine in each case one panel or one laser assigned to the machining track machines a first panel and the other two lasers assigned to the machining track machine a second panel or each of the three lasers assigned to the machining track machines in each case one panel at the same time. Through such an arrangement of the lasers the machining duration for the carrier substrate is significantly shortened.

It is also possible for the at least one layer of the carrier substrate to be perforated, in particular in step c), in the one or more first and/or second regions by means of a laser flash, wherein the laser flash is generated in the shape of the one or more first and/or second regions by means of a mask located in the beam path of the laser radiation.

The laser is preferably operated at a writing speed of in particular 3000 mm/s, preferably of 2200 mm/s, further preferably of 2000 mm/s. It is further possible for the laser to have a writing surface area of 200×200 mm, preferably of 150×150 mm, further preferably of 140×140 mm.

The carrier substrate is expediently transported, in particular in step c) and/or d), at a running speed of 200 m/min, preferably of 130 m/min, further preferably of 120 m/min, still further preferably of 60 m/min. It is hereby ensured that the at least one layer of the carrier substrate in the one or more first and/or second and/or third regions is reliably perforated or removed residue-free depending on the writing surface area of the laser, the writing speed of the laser and/or the laser power.

Preferred embodiments of the device for carrying out the method are described in the following:

It is advantageous if the device further comprises at least one of the following units:
a sensor unit, in particular an optical sensor unit, for detecting the position of at least one security feature of the carrier substrate, in particular a watermark and/or a printed feature;
a computer unit for correcting the detected position data by means of an algorithm;
a second unit comprising a laser for perforating at least one layer of the carrier substrate, in particular in one or more second regions;
a second application device for applying one or more, in particular transparent, plastic plies to the single- or multi-layered carrier substrate;
a printing unit. In particular a printing mechanism, for printing on the carrier substrate;
a cutting unit, in particular for dividing the carrier substrate into individual panels;
a stamping unit, in particular for cutting out the at least one third region.

The steps of the method, in particular the steps of the method a), b), c), are preferably performed in one device or performed in several devices or distributed onto several devices. One or more of the steps of the method are effected in particular in an inline process, i.e. in one device which comprises the corresponding units for performing the corresponding method steps, or in an offline process, i.e. in several devices which in each case comprise one or more units for performing the respective corresponding method steps. The sequence of the steps of the method is effected preferably without interruption in an inline process.

For example, the steps of the method a), b), c) can be performed without interruption in an inline process in one device, or the steps of the method a) and b) are performed in an inline process without interruption in a first device having the corresponding units and the step of the method is performed in an offline process relative to the steps of the method a) and b) in a second device having the corresponding unit. In this example, there is thus an interruption between the steps of the method a), b) and the step of the method c).

It is also possible for one or more of the steps of the method to be performed repeatedly by a device comprising the corresponding one or more units. For example, the step of the method c) can be performed in a first pass by the device comprising the corresponding one or more units, and then repeating the step c) in a second pass, in particular in a modified variant.

One or more or all of the steps of the method are preferably performed in one or more roll-to-roll processes or in one or more step-and-repeat processes, wherein these processes are performed by one device or by several different devices. The device or the devices preferably comprise the corresponding units needed to perform the steps of the method.

The carrier substrate is preferably present rolled up on a roll and is unrolled in order to be provided to a device comprising one or more of the units for performing one or more of the method steps. After the method steps have been performed by the device, the carrier substrate is preferably rolled up again, wherein the rolled-up carrier substrate is provided, in particular in the case of an offline process, to one or more further devices comprising one or more of the units.

It is further possible for the carrier substrate to be provided as a sheet or as a plurality of sheets.

For example, it is possible for each of the steps of the method, in particular in the case of an offline process, to be assigned an individual device comprising one or more of the corresponding units, wherein the carrier substrate is preferably stored temporarily as a roll as a stack of sheets during the interruptions of the offline process.

Embodiment examples of the invention are explained by way of example below with the aid of the attached figures, not to scale.

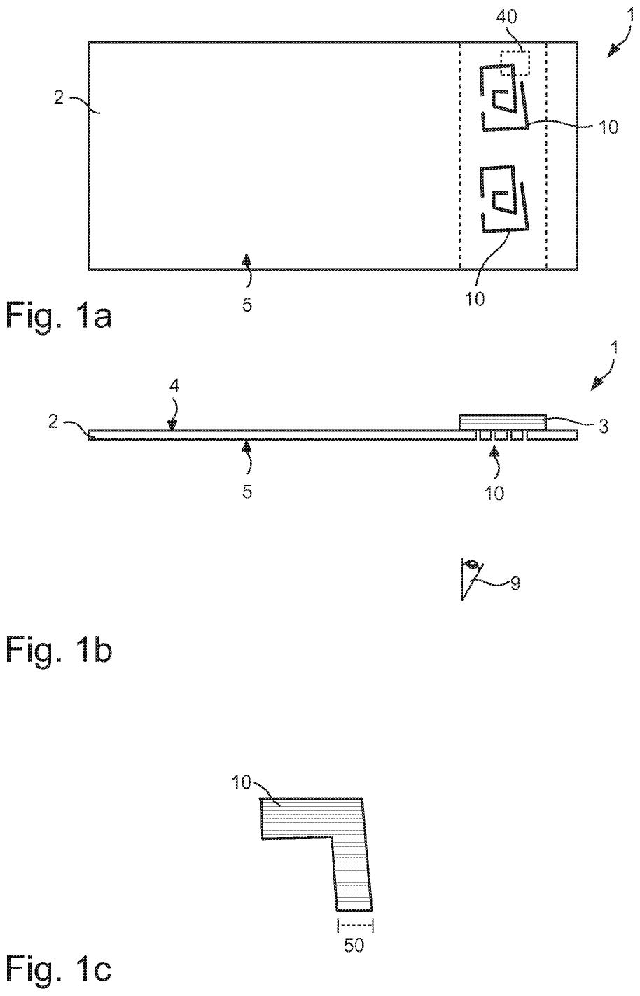

FIG. 1a and FIG. 1b schematically show a document in top view and in a sectional representation

FIG. 1c schematically shows an enlarged section of FIG. 1a

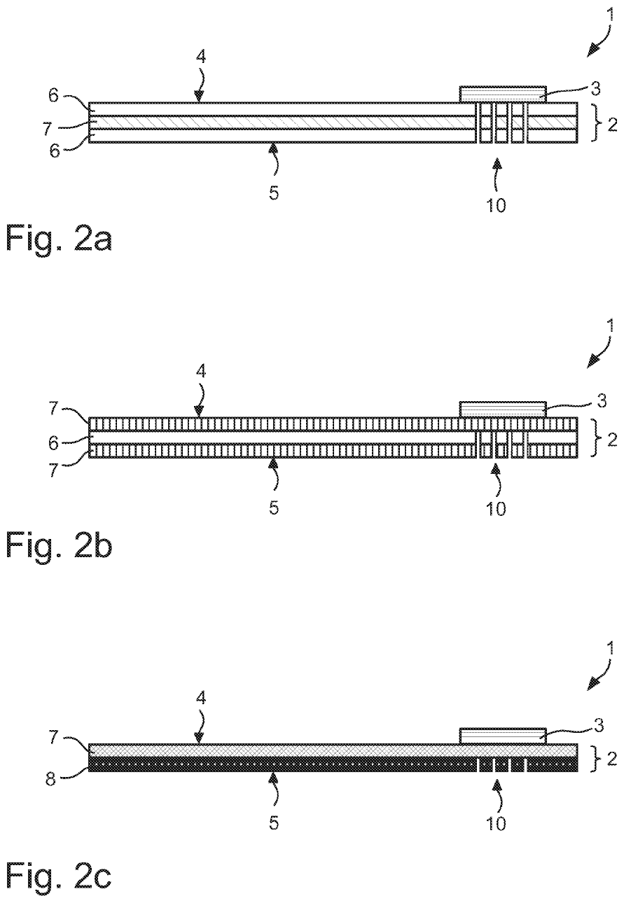

FIG. 2a to FIG. 2c schematically show sectional representations of documents

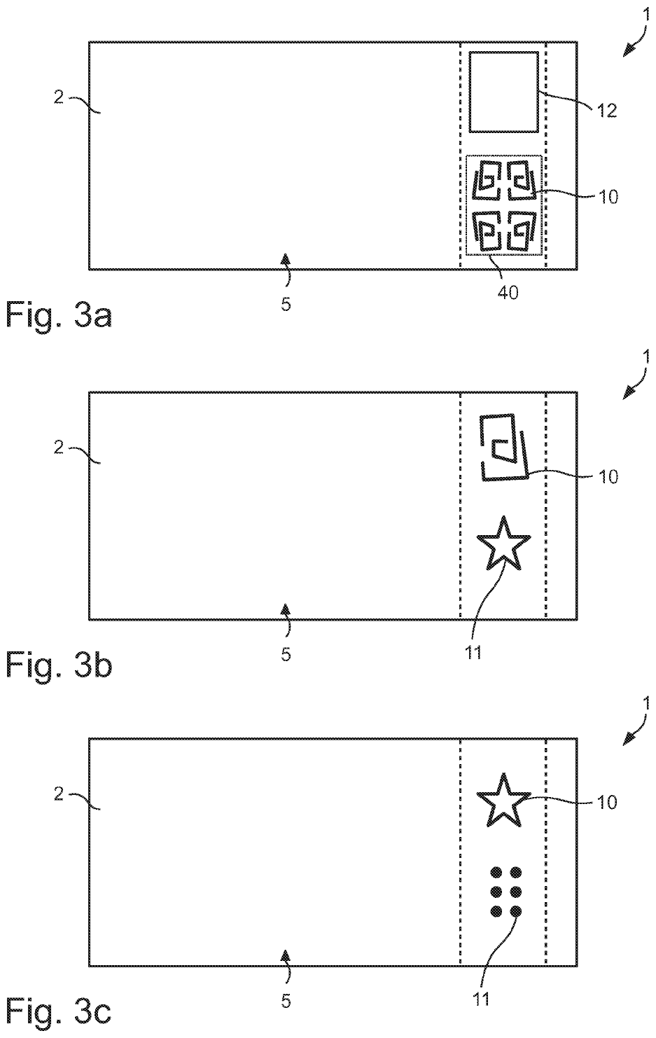

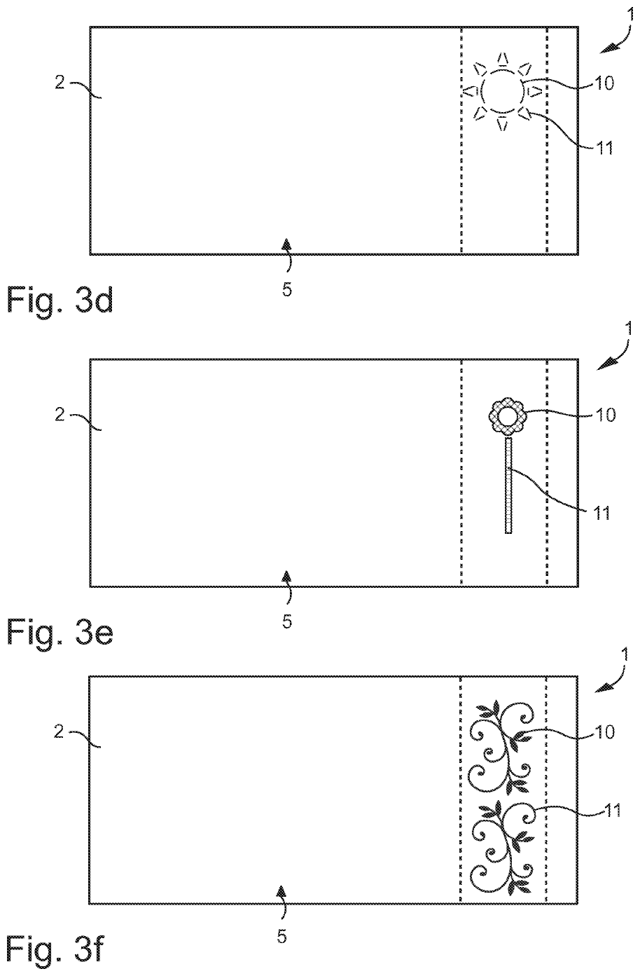

FIG. 3a to FIG. 3f schematically show documents in top view

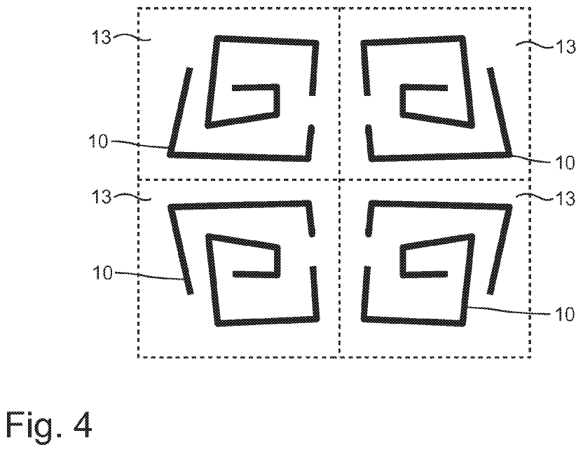

FIG. 4 schematically shows an enlarged section of FIG. 3a

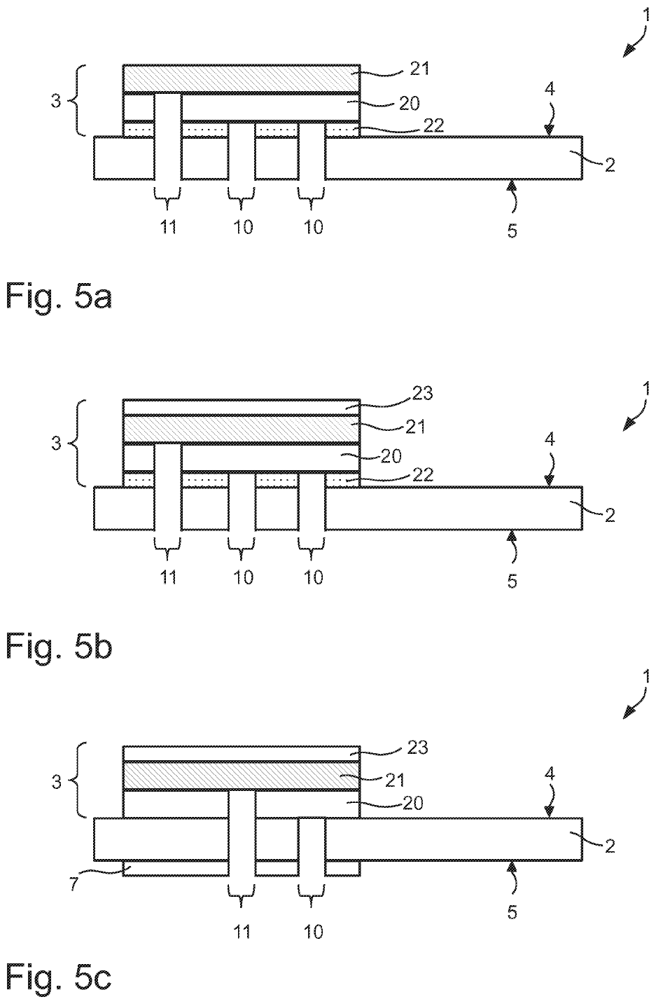

FIG. 5a to FIG. 5c schematically show sectional representations of documents

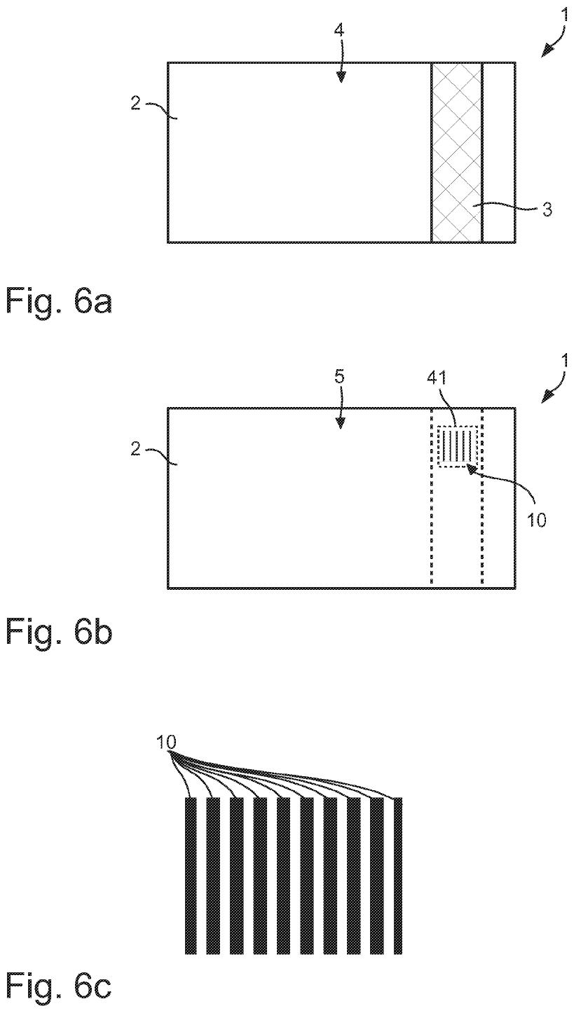

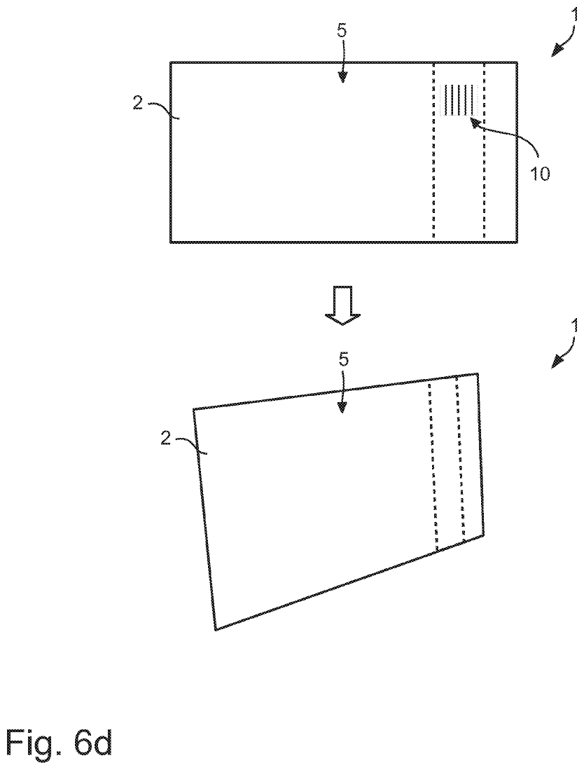

FIG. 6a to FIG. 6d schematically show a document

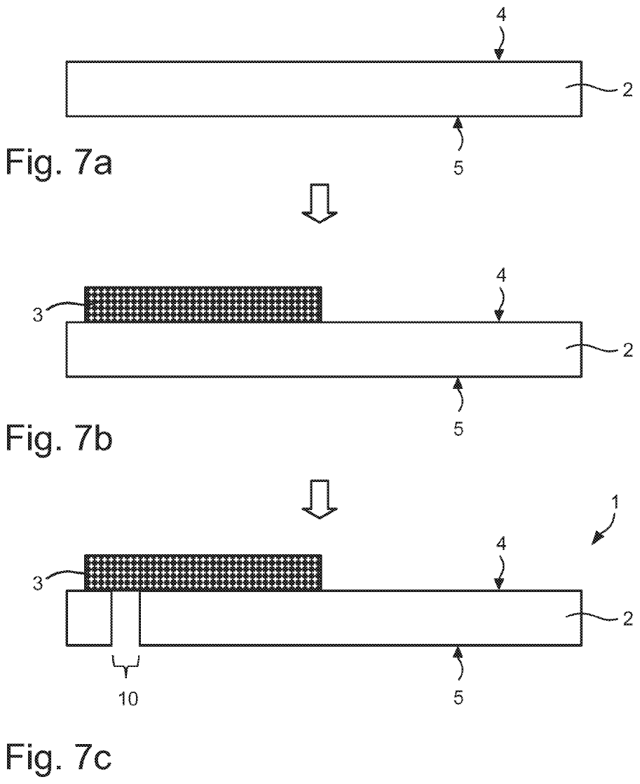

FIG. 7a to FIG. 7c schematically show method steps for producing a document

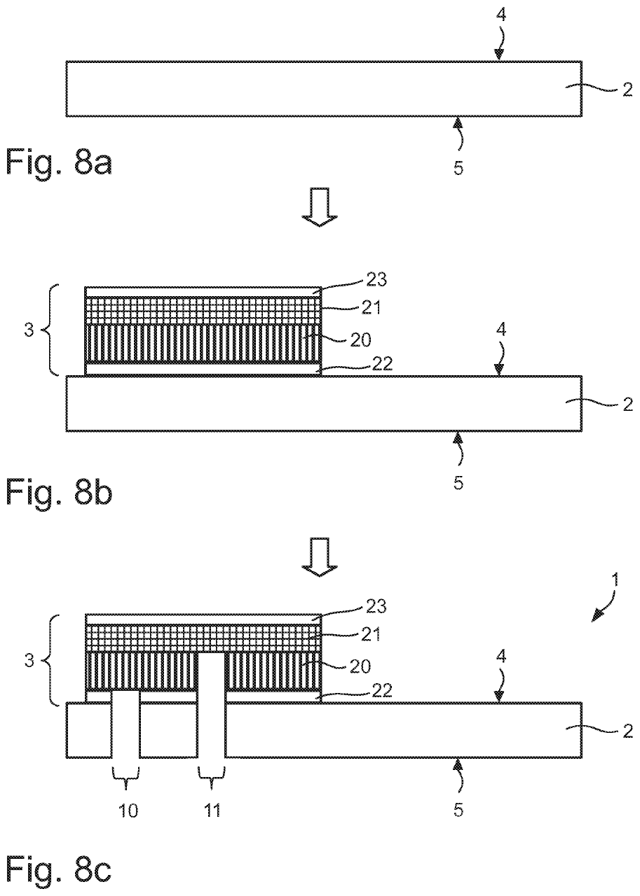

FIG. 8a to FIG. 8c schematically show method steps for producing a document

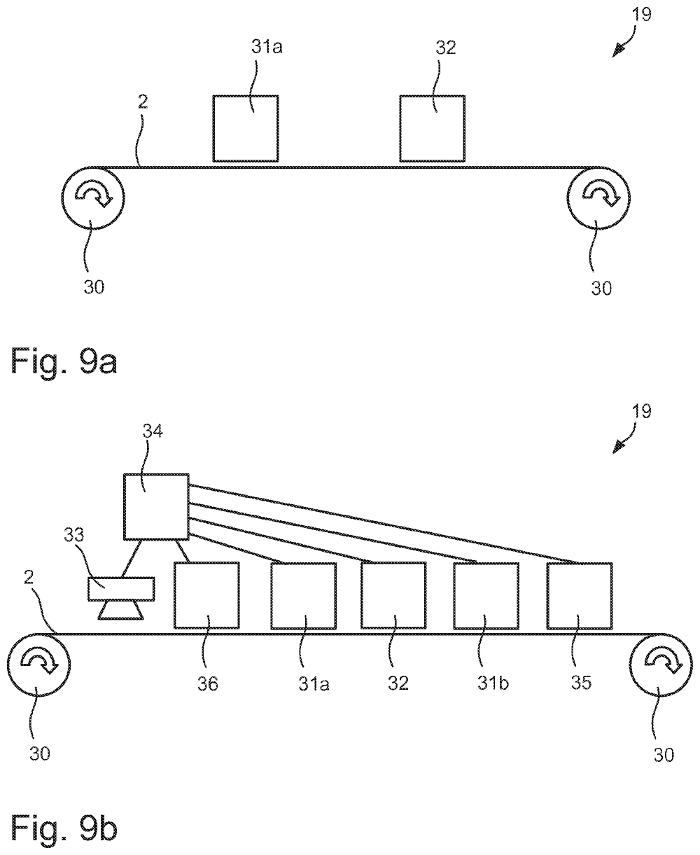

FIG. 9a and FIG. 9b schematically show devices for carrying out the method

FIG. 1a and FIG. 1b show a document 1 with a carrier substrate 2 and a decorative ply 3 applied to the surface 4 of the carrier substrate 2.

The document 1 is in particular a security document such as a banknote, an identity document, a visa or a security.

The carrier substrate 2 is preferably a paper substrate, in particular a single-layered paper substrate. It is also possible for the carrier substrate 2 to comprise cotton fibers, wood fibers, pulp fibers, textile fibers and/or plastic fibers. The carrier substrate 2 preferably has a layer thickness between 30 μm and 250 μm, preferably between 50 μm and 100 μm. It is also possible for the carrier substrate 2 to have additives, in particular security fibers and/or security pigments and/or dyes and/or watermarks. The carrier substrate 2 shown in FIG. 1a and FIG. 1b is a single-layered paper substrate with a layer thickness of 80 μm.

As shown in FIG. 1b, the decorative ply 3 is applied to the upper side 4 of the carrier substrate 2. It is possible for the decorative ply 3 to be formed single- or multi-layered. The decorative ply 3 preferably has one or more color layers, one or more layers with optically variable pigments, one or more thin-film layer systems, one or more layers generating an optically variable effect, one or more layers with color pigments and/or dissolved dyes and/or one or more layers with microstructures. The layers advantageously generate at least one color effect in the range of the wavelengths visible to the human eye, in particular in the wavelength range of from 400 nm to 800 nm, when the document 1 is viewed from the underside 5 of the carrier substrate 2. It is advantageous here if the microstructures are selected from the group Kinegram®, holograms, blazed gratings, in particular asymmetrical sawtooth relief structures, diffraction structures, in particular linear sinusoidal diffraction gratings or crossed sinusoidal diffraction gratings or linear single- or multi-step rectangular gratings or crossed single- or multi-step rectangular gratings, mirror surfaces, matte structures, in particular anisotropic or isotropic matte structures, or combinations of these structures.

As in FIG. 1a and FIG. 1b, the carrier substrate 2 is perforated in the regions 10, represented in black here, with the result that the decorative ply 3 is visible in the regions 10 to an observer 9 of the document 1 from the underside 5 of the carrier substrate 2. Here the carrier substrate 2 is perforated by means of a laser.

The terms upper side 4 and/or underside 5 here serve in particular to distinguish between the surfaces of the carrier substrate 2 and in particular represent a frame of reference. However, it is also possible, instead of these terms of reference, to use the terms first side and second side.

By region is meant here in each case a defined surface area of a layer or ply which is occupied when viewed perpendicular to a plane spanned by the carrier substrate 2. Thus, for example, the carrier substrate 2 has the regions 10, wherein each of the regions 10 in each case occupies a defined surface area when viewed perpendicular to a plane spanned by the carrier substrate 2.

By perforation of a layer is meant here the complete removal of a layer, in particular by means of laser cutting and/or laser ablation. If, for example, a layer is perforated in a region 10, the corresponding layer has been completely removed in this region 10. The perforation here is preferably effected on the basis of laser cutting and/or laser ablation, with the result that the perforated layers are worn away and/or ablated and/or burnt up and/or evaporated residue-free in the corresponding regions 10. Thus, for example in FIG. 1a and FIG. 1b, the carrier substrate 2 is completely removed in the regions 10, in particular by means of laser cutting and/or laser ablation, with the result that the carrier substrate 2 is worn away residue-free in the regions 10.

By visible is meant here that the decorative layer 3 is recognizable for the observer 9 when the document 1 is viewed by the naked human eye from the underside 5 of the carrier substrate 2.

As indicated in FIG. 1a by the dashed lines, the decorative ply 3 is applied to the upper side 4 of the carrier substrate 2 only in regions. The example in FIG. 1a shows a strip form of the decorative ply 3, wherein alternatively or additionally other forms, for example a patch form, are also possible. The decorative ply 3 further completely covers the regions 10 when viewed perpendicular to a plane spanned by the carrier substrate 2. It is hereby ensured that the decorative ply 3 or the optical effects generated by the decorative ply are visible to the observer 9 in all perforated regions 10 from the underside 5 of the carrier substrate 2.

As shown in FIG. 1a, the regions 10 are designed linear. However, it is also possible for the regions 10 to be designed as a graphic motif, alphanumeric, punctiform and/or as machine-readable code. A pattern can be, for example, a graphically designed outline, a figurative representation, an image, a motif, a symbol, a logo, a portrait, an alphanumeric character, a text and the like.

FIG. 1c schematically shows an enlarged section 40 of FIG. 1a. As shown in FIG. 1c, the decorative ply 3 is recognizable in the regions 10 in which the carrier substrate 2 is perforated. The regions 10, as shown in FIG. 1c, further have the line width 50. The line width 50 is preferably at most 2 mm, preferably at most 1 mm, when viewed perpendicular to a plane spanned by the carrier substrate 2. However, it is expedient if the line width 50 of the regions 10 when viewed perpendicular to a plane spanned by the carrier substrate 2 is chosen to be at least so wide that the decorative ply 3 is visible to the naked human eye in the region 10 when the document 1 is viewed from the underside 5 of the carrier substrate 2. The line width 50 is therefore preferably at least 20 μm, particularly at least 50 μm, further preferably at least 100 μm, in particular preferably at least 200 μm. The line width shown in FIG. 1c is 200 μm. The above indications of size with respect to the line width of the regions can, however, also relate to the width and/or the diameter of the regions 10 depending on the design of the regions 10. Thus, it is possible, if the regions are formed as circles, for these to have a diameter between a minimum of 20 μm, preferably a minimum of 50 μm, further preferably a minimum of 100 μm, in particular preferably at least 200 μm, and at most 2 mm, preferably at most 1 mm.

As shown in FIG. 1c, the optically perceptible effect for the observer 9 in the regions 10 is defined and/or predetermined by the decorative ply, as the carrier substrate 2 is perforated only in the regions 10 when the document 1 is viewed from the underside 5 of the carrier substrate 2. The decorative ply 3 is thus visible to the observer 9 only in these perforated regions 10. Through its design, the decorative ply 3 thus defines the optical effects visible to the observer 9 in the perforated regions 10 from the underside 5 of the carrier substrate 2.

FIG. 2a to FIG. 2c schematically show sectional representations of documents 1.

The document 1 shown in FIG. 2a comprises a carrier substrate 2 and a decorative ply 3 applied to the upper side 4 of the carrier substrate 2.

The carrier substrate 2 shown in FIG. 2a is formed as a multi-layered carrier substrate 2 and comprises the layers 6, 7. The carrier substrate 2 shown in FIG. 2a is a multi-layered hybrid substrate which has two paper plies 6 and a plastic ply 7. The plastic ply 7 is preferably a plastic ply made of polyamide. The carrier substrate 2 preferably has a layer thickness between 30 μm and 250 μm, preferably between 50 μm and 100 μm.

As shown in FIG. 2a, both the paper plies 6 and the plastic ply 7 are perforated in the regions 10, with the result that the carrier substrate is perforated completely in the regions 10 such that the decorative ply 3 is visible in the regions 10 when the document 1 is viewed from the underside 5 of the multi-layered carrier substrate 2. In particular as the paper plies 6 on the outside are matte and thus substantially lightproof, a complete perforation of the carrier substrate 2 is necessary in order to make the decorative ply 3 visible to an observer when the document 1 is viewed from the underside 5 of the multi-layered carrier substrate 2.

With respect to the design of the regions 10 as well as of the decorative ply 3, reference is made here to the above statements.

The document 1 shown in FIG. 2b comprises a carrier substrate 2 and a decorative ply 3 applied to the upper side 4 of the carrier substrate 2.

The carrier substrate 2 shown in FIG. 2b is formed as a multi-layered carrier substrate 2 and comprises the layers 6, 7. The carrier substrate 2 shown in FIG. 2b is a multi-layered carrier substrate 2 which has one paper ply 6 and two plastic plies 7. The plastic plies 7 here preferably comprise polyester and/or polyethylene terephthalate (=PET). It is further possible for at least one of the plastic plies 7 to be transparent. The plastic plies 7 shown in FIG. 2b are transparent plastic plies.

By transparent is meant here the property of materials to allow light from the wavelength range visible to the human eye through, in particular from the wavelength range between 380 nm and 780 nm.

As shown in FIG. 2b, the paper ply 6 and the plastic ply 7 arranged on the underside 5 of the carrier substrate 2 are perforated in the regions 10. As the plastic plies 7 are designed transparent, in particular as the plastic ply 7 not perforated in the region 10 and arranged on the upper side of the carrier substrate 2 is transparent, the decorative ply 3 is visible in the regions 10 when the document 1 is viewed from the underside 5 of the multi-layered carrier substrate 2. As shown in FIG. 2b, the carrier substrate 2 is therefore not completely perforated, wherein the decorative ply 3 is, however, still visible in the regions 10 when the document 1 is viewed from the underside 5 of the multi-layered carrier substrate 2.

With respect to the design of the regions 10 as well as of the decorative ply 3, reference is made here to the above statements.

The document 1 shown in FIG. 2c comprises a carrier substrate 2 and a decorative ply 3 applied to the upper side 4 of the carrier substrate 2.

The carrier substrate 2 shown in FIG. 2c is formed as a multi-layered carrier substrate 2 and comprises the layers 7, 8. The carrier substrate 2 shown in FIG. 2c is a multi-layered carrier substrate 2 which has a transparent plastic ply 7 and an opaque layer 8. The opaque layer 8 is preferably an opacified varnish layer and/or a printed color layer. The transparent plastic ply 7 is preferably a polymer layer.

As shown in FIG. 2c, the opaque layer 8 is perforated in the regions 10. As the plastic ply 7 is designed transparent, the decorative ply 3 is visible in the regions 10 when the document 1 is viewed from the underside 5 of the multi-layered carrier substrate 2. As shown in FIG. 2c, the carrier substrate 2 is therefore not completely perforated, wherein the decorative ply 3 is, however, still visible in the regions 10 when the document 1 is viewed from the underside of the multi-layered carrier substrate 2. As shown in FIG. 2c, at least the layer 8 of the carrier substrate 2 is perforated in the regions 10. A perforation of the transparent plastic ply 7 is therefore not necessary in order to be able still to recognize the decorative ply 3 in the regions 10 when the document 1 is viewed from the underside 5 of the multi-layered carrier substrate 2.

With respect to the design of the regions 10 as well as of the decorative ply 3, reference is made here to the above statements.

FIG. 3a to FIG. 3f schematically show further embodiment variants of documents 1 in top view from the underside of the carrier substrate 2, which in each case comprise a carrier substrate 2, as well as a decorative ply applied to the upper side of the carrier substrate 2.

As indicated in FIG. 3a to FIG. 3f by the dashed lines, the decorative ply is applied to the upper side of the carrier substrate 2 only in regions, wherein the decorative ply completely covers the regions 10, 11 and/or 12 when viewed perpendicular to a plane spanned by the carrier substrate 2. With respect to the further design of the decorative ply, reference is made here to the above statements. With respect to the design of the carrier substrate 2, reference is likewise made here to the above statements.

As shown in FIG. 3a, the carrier substrate 2 is perforated in the regions 10 such that the decorative ply is visible in the regions 10 of the document 1 from the underside of the carrier substrate 2.

As shown in FIG. 3a, the regions 10 here are preferably designed linear. Each of the regions 10 further represents a pattern. A pattern can be, for example, a graphically designed outline, a figurative representation, an image, a motif, a symbol, a logo, a portrait, an alphanumeric character, a text and the like.

The carrier substrate 2, as shown in FIG. 3a, further has a recess in the region 12. The region 12 is preferably cut out by means of stamping and/or by means of a laser. The region 12 is, as shown in FIG. 3a, formed rectangular. However, it is also possible for the region 12 to be formed oval, circular or patterned. The region 12, as represented schematically in FIG. 3a, further occupies a much larger surface area than the regions 10. The region 12 preferably has a surface area at least 4 times, preferably at least 8 times, further preferably at least 10 times, larger than that of the regions 10. The region 12 is preferably completed during the production of the document 1 before the perforation of the regions 10. The decorative ply 3 is visible in the region 12 when the document 1 is viewed from the underside of the carrier substrate 2. It is also possible here for the regions 10 to be connected to the region 12.

As shown in FIG. 3b, the carrier substrate 2 is perforated in the regions 10 and 11 such the decorative ply is visible in the regions 10 and 11 when the document 1 is viewed from the underside of the carrier substrate 2.

As shown in FIG. 3b, the region 10 here is preferably designed linear. The region 10 further represents a patter. The region 11 here is, as shown in FIG. 3b, likewise designed linear and forms a closed contour which represents a star-shaped pattern. The regions 10 and 11 here were perforated by means of a laser and have a line width of 300 μm. It hereby becomes possible to uncover roughly prestructured features on the underside of the decorative ply, such as for example color surface areas or surface areas with optically variable effects, by means of the delicate perforations in the regions 10 and 11 of the carrier substrate 2 such that these are visible when the document 1 is viewed from the underside 5 of the carrier substrate 2.

As shown in FIG. 3b, the carrier substrate 2 is perforated both in the region 10 and in the region 11 such that the decorative ply is visible in the regions 10 and 11 when the document 1 is viewed from the underside 5 of the carrier substrate 2, wherein the region 11 has a different pattern from the region 10. Thus, when the document 1 is viewed from the underside 5 of the carrier substrate 2, the decorative ply defines the optical effects perceptible for an observer, in particular optically variable effects, both in the regions 10 and in the regions 11.

The document 1 shown in FIG. 3c has the regions 10 and 11. The region 10 corresponds to the region 11 of FIG. 3b, with the result that reference is made to the above statements with respect to the design of the region 10. The regions 11 are formed circular and have a diameter of from 50 μm to 500 μm. The regions 11 are arranged in a grid. The grid width advantageously corresponds substantially to the layer thickness of the carrier substrate 2. However, it is also possible for the grid width to be between 100 μm and 5000 μm, preferably between 500 μm and 2500 μm. In particular, the next spacing between two neighboring ones of the regions 11 is between 100 μm and 5000 μm, preferably between 500 μm and 2500 μm. Here the carrier substrate 2 was perforated in the regions 11 by means of a laser such that the decorative ply is visible in the regions 11 of the document 1 from the underside of the carrier substrate 2.

For example, one or more items of information haptically detectable for a person, in particular haptically detectable information about the value of a banknote or haptically detectable information with respect to the holder of a document, can be provided in Braille by such an arrangement of the regions 11.

The document 1 shown in FIG. 3d has the regions 10 and 11. The regions 11 here are designed linear and in each case form a contour closed in sections, in the shape of a triangle. The line width of the regions 11 in FIG. 3d is 250 μm.

The region 10 is designed linear and likewise forms a contour closed in sections, in the shape of a circle. The line width of the region 10 in FIG. 3d is 350 μm, with the result that in the decorative ply is visible both in the regions 11 and in the region 10 when the document 1 is viewed from the underside of the carrier substrate 2.

By a contour closed in sections is meant that the perforations are provided such that no completely enclosed regions 10 and/or 11 form, but rather the regions 10 and 11 are defined by contours interrupted in sections. For this purpose, the perforations are designed such that interruptions in the perforations are provided at regular and/or irregular spacings, wherein the carrier substrate is not removed in these interruptions, with the result that the regions 10 and/or 11 are joined together at least by one connection, preferably by several connections.

In FIGS. 3e to 3d the carrier substrate 2 is in each case completely perforated in the regions 10 and 11, in each case represented in black. However, it is also possible for, as explained previously, only in particular the opaque layers of the carrier substrate 2 to be perforated from the direction of the underside 5 of the carrier substrate 2, wherein the decorative ply is nevertheless visible when the document 1 is viewed from the underside of the carrier substrate 2, in particular as the non-perforated layers of the carrier substrate 2 are transparent. If the regions 10 and 11, like for example the region 11 in FIG. 3b or the region 10 in FIG. 3c, enclose a region of the carrier substrate 2, this region of the carrier substrate is not removed, as the perforation of the regions 10 and 11 is preferably effected after application of the decorative ply, with the result that the regions of the carrier substrate 2 enclosed by the regions 10 and 11 adhere to the decorative ply and are therefore not removed, i.e. the decorative ply fixes the regions of the carrier substrate 2 enclosed by a closed contour in place. Thus, it is possible for the regions 10 and 11 to form closed contours, without the enclosed regions of the carrier substrate falling out for example during the production process.

The document 2 shown in FIG. 3e has the regions 10 and 11. The region 11 here is designed linear and has a line width of 500 μm. The region 10 forms, as shown in FIG. 3e, a closed circular contour and further has different line widths, with the result that the shape of a flower forms. The regions 10 and 11 are not connected to each other, with the result that the region 10 and the region 11 are separated by a region in which the carrier substrate 2 is not perforated by means of a laser. The line widths of the region 10 here vary between 500 μm and 750 μm. Such variations of the line widths can be generated for example by variations of the beam diameter in the focal point during the perforation of the carrier substrate 2. Here, the focus of the laser is advantageously altered, in particular by means of a lens system. As can be seen from FIG. 3e, the decorative ply is visible in the regions 10 and 11 when the document 1 is viewed from the underside 5 of the carrier substrate 2, wherein the decorative ply has different colors, in particular from the RGB color space, indicated by the different shading in FIG. 3e, in the regions 10 and 11. Thus, the decorative ply has a red color shade in the region 10 and a green color shade in the region 11. The regions 10 and 11, as shown in FIG. 3e, are further connected to each other.

It is further advantageous to separate the regions 10 and 11 from each other. The spacing between the two regions 10 and 11 will preferably be chosen such that possible positional tolerances of the different colors on the decorative ply 3 relative to the regions 10 and 11 are concealed or hidden below this spacing.

In FIG. 3e also the carrier substrate 2 is in each case completely perforated in the regions 10 and 11, represented shaded. However, it is also possible for, as already explained above, only in particular the opaque layers of the carrier substrate 2 to be perforated from the direction of the underside 5 of the carrier substrate 2, wherein the decorative ply is nevertheless visible when the document 1 is viewed from the underside of the carrier substrate 2, in particular as the non-perforated layers of the carrier substrate 2 are transparent. The region 10 forms a closed contour. As, however, the region 10 was not perforated by means of a laser until after the application of the decorative ply, here too the region of the carrier substrate 2 enclosed by the region 10 is fixed in place by the decorative ply. For further stabilization, it is possible to apply a transparent plastic ply, in particular in the region of the decorative ply applied to the upper side, to the underside of the carrier substrate 2.

FIG. 3f shows a region 10 and 11 respectively, which in each case are provided as delicate perforation, which are designed as a tendril-like motif, wherein the regions 10 and 11 are in each case joined together.

FIG. 4 schematically shows an enlarged section 40 of FIG. 3a. As shown in FIG. 4, each region 10 lies within a predefined region of surface 13, which is represented by the dashed lines in FIG. 4. Each of the regions 10 in which the carrier substrate is perforated by means of a laser and/or in which preferably the opaque layers of the carrier substrate are perforated by means of a laser preferably comprises at most 25%, preferably at most 10%, of the surface area of the respective predefined region of surface 13 when viewed perpendicular to a plane spanned by the carrier substrate.

By predefined is meant here a predetermined value or range of values or a predetermined shape or geometry, in particular which comprises 100% of the surface area. Thus, a predefined region of surface 13 is determined by a rectangle with a particular surface coverage in FIG. 4. This region of surface preferably corresponds to 100%, with the result that at most 25%, preferably at most 10%, of this predefined region of surface 13 is removed by perforations in the regions 10.

Furthermore, it is also possible for the decorative ply to completely cover the predefined regions of surface 13 when viewed perpendicular to a plane spanned by the carrier substrate.

FIG. 5a to FIG. 5c schematically show sectional representations of documents 1 which comprise a carrier substrate 2 and a decorative ply 3.

The document 1 shown in FIG. 5a here comprises the carrier substrate 2 as well as the decorative ply 3. The carrier substrate 2 is a single-layered paper substrate with a layer thickness of 80 μm. However, as explained above, it is also possible for the carrier substrate 2 to be a multi-layered carrier substrate. With respect to such a design, reference is made to the above statements.

The decorative ply 3 shown in FIG. 5a comprises the layers 20, 21 and 22. The decorative ply 3 is applied to the upper side 4 of the carrier substrate 2 in regions.

The layer 20 is a thin-film layer system, which generates an optically variable effect dependent on the viewing angle. For this purpose, the thin-film layer system preferably has an interference layer structure. The interference layer structure preferably has a reflective layer, such as for example a metal layer, an absorption layer and a transparent dielectric spacer layer, which satisfies the λ/4 or λ/2 condition for a wavelength in the range of visible light. However, it is also possible for the thin-film layer system to be built up from a sequence of high- and low-refractive-index layers. As shown in FIG. 5a, the layer 20 here is arranged between the upper side 4 of the carrier substrate 2 and the layer 21.

By the λ/2 or λ/4 condition is meant the optical path difference, i.e. the path difference of two or more coherent waves of the incident light. This path difference is decisive for the occurrence of interference phenomena. If the optical path difference of two waves of equal wavelength λ and equal amplitude is precisely half a wavelength (and/or plus any desired integer multiple of the wavelength), the two partial waves cancel each other out. This weakening of intensity is called destructive interference. If the optical path difference is an integer multiple of the wavelength, the amplitudes of the two partial waves add up. In this case, there is constructive interference. In the case of values in between, a partial cancellation results.

The layer 21 comprises a replication varnish layer with microstructures molded at least in regions as well as a reflective layer at least in regions. The replication varnish layer consists for example of a thermoplastic varnish, into which the microstructures are molded by means of heat and pressure through the action of an embossing tool. It is further also possible for the replication varnish layer to be formed by a UV-crosslinking varnish and for the microstructures to be molded into the replication varnish layer by means of UV replication. The microstructures are molded onto the uncured replication varnish layer through the action of an embossing tool and the replication varnish layer is cured by irradiation with UV light before and/or directly during and/or after the molding. It is further advantageous if the replication varnish layer has a layer thickness of between 0.2 μm and 4 μm, preferably 0.3 μm and 2 μm, further preferably 0.4 μm and 1.5 μm. The microstructures molded in regions are here formed for example as sinusoidal diffraction gratings and generate an optically variable effect dependent on the viewing angle. However, it is also possible for the microstructures to be selected from the group Kinegram®, holograms, blazed gratings, in particular asymmetrical sawtooth relief structures, diffraction structures, in particular linear sinusoidal diffraction gratings or crossed sinusoidal diffraction gratings or linear single- or multi-step rectangular gratings or crossed single- or multi-step rectangular gratings, mirror surfaces, matte structures, in particular anisotropic or isotropic matte structures, or combinations of these structures.

The reflective layer is preferably a metal layer. The metal layer is preferably a metal layer made of chromium, aluminum, gold, copper, silver or an alloy of such metals, in particular which is vapor-deposited under vacuum in a layer thickness of from 0.01 μm to 0.15 μm. It is further also possible for the reflective layer to be formed by a transparent reflective layer, for example a thin or finely structured metallic layer or an HRI or LRI layer (HRI=high refractive index, LRI=low refractive index). Such a dielectric reflective layer consists for example of a vapor-deposited layer made of a metal oxide, metal sulfide, titanium oxide, etc. with a thickness of from 10 nm to 150 nm.

In addition to the layers 20 and 21 shown in FIG. 5a, the decorative layer 3 can, as an alternative to the layers 20 and 21, also comprise other or also further layers, in particular selected from the group one or more color layers, one or more layers with optically variable pigments, one or more thin-film layer systems, one or more layers generating an optically variable effect, one or more layers with color pigments and/or dissolved dyes and/or one or more layers with microstructures, in particular wherein the layers generate at least one color effect in the range of the wavelengths visible to the human eye, in particular in the wavelength range of from 400 nm to 800 nm, when the document is viewed from the underside of the carrier substrate.

The layer 22 is an adhesion layer. The adhesion layer is preferably a hot- or cold-glue layer, which comprises in particular acrylates, PVC, polyurethane or polyester. The layer 22 is a hot-glue layer with a layer thickness of from 0.1 μm to 10 μm, preferably of from 0.5 μm to 5 μm. The decorative ply 3 shown in FIG. 5a is therefore in particular a transfer ply of a hot-stamping film. However, it is also possible for the decorative ply to be a transfer ply of a cold-stamping film or for the decorative ply to be a laminating film.

As shown in FIG. 5a, the carrier substrate 2 and the layer 22 of the decorative ply 3 are perforated in the regions 10 by means of a laser such that the layer 20 is visible in regions 10 when the document 1 is viewed from the underside 5 of the carrier substrate 2. Here, not only the carrier substrate 2, but further also the layer 22, was thus perforated by means of a laser. Further, as shown in FIG. 5a, the carrier substrate 2 and the layers 22 and 20 have been perforated by means of a laser in the region 11. The layer 21 has hereby been uncovered in the region 11 from the underside 5 of the carrier substrate 2, with the result that the layer 22 is visible in the region 11 when the document 1 is viewed from the underside 5 of the carrier substrate 2. Therefore, if the document 1 of FIG. 5a is viewed from the underside 5 of the carrier substrate, the layer 20 is visible in the regions 10 and the layer 21 is visible in the region 11.

FIG. 5b corresponds to FIG. 5a, with the difference that the decorative ply in FIG. 5b further comprises the protective varnish layer 23. The protective varnish layer is preferably a layer of PET (=polyethylene terephthalate), PEN (=polyethylene naphthalate), PE (=polyethylene), PI=(polyimide), PP (=polypropylene), PC or PTFE (=polytetrafluoroethylene). The layer thickness of the protective varnish layer is advantageously between 0.5 μm and 30 μm, preferably between 3 μm and 10 μm. The protective varnish layer shown in FIG. 5b is a layer of PET with a layer thickness of 16 μm. With respect to the further design of the layers shown in FIG. 5b, reference is made here to the above statements.

The document 1 shown in FIG. 5c comprises a carrier substrate 2, a decorative ply 3, as well as a transparent plastic ply 7. The decorative ply 3 of FIG. 5c corresponds to the decorative ply of FIG. 5a, with the difference that the decorative ply 3 does not comprise an adhesion layer 22 and is applied directly to the carrier substrate 2. The transparent plastic ply 7 is, as shown in FIG. 5c, applied to the underside 5 of the carrier substrate 2 in the region in which the decorative ply 3 is applied to the upper side 4 of the carrier substrate 2. As shown in FIG. 5c, the transparent plastic ply 7 and the carrier substrate 2 are perforated in the regions 10 and 11 by means of a laser. The layer 20 is further perforated in the region 11, with the result that the layer 21 is visible in the region 11 when the document 1 is viewed from the underside 5 of the carrier substrate 2. With respect to the further designs of the layers, reference is made here to the above statements.

FIG. 6a to FIG. 6d schematically show a document 1.

In FIG. 6a the document 1 is shown in top view when the document 1 is viewed from the upper side 4 of the carrier substrate 2. As shown in FIG. 6a, the document 1 has the decorative ply 3, which is applied to the upper side 4 of the carrier substrate 2.

In FIG. 6b the document 1 is shown in top view when the document 1 is viewed from the underside 5 of the carrier substrate 2. The carrier substrate 2 is perforated in the regions 10 by means of a laser such that the decorative ply 3 is visible in the regions 10 when the document 1 is viewed from the underside 5 of the carrier substrate 2. The regions 10 are further arranged on the side of the carrier substrate opposite the decorative ply 3, which is indicated by the dashed lines. As shown in FIG. 6b, the regions 10 here are designed linear and arranged in a line grid.

FIG. 6c schematically shows an enlarged section 41 of FIG. 6b. As shown in FIG. 6c, the regions 10 represented in black, in which the carrier substrate 2 is perforated by means of a laser such that the decorative ply 3 is visible in the regions 10 when the document 1 is viewed from the underside 5 of the carrier substrate 2, are designed linear and arranged in a grid. The grid width of the line grid advantageously corresponds substantially to the layer thickness of the carrier substrate 2. However, it is also possible for the grid width of the line grid to be between 30 μm and 250 μm, preferably between 50 μm and 100 μm, further preferably between 70 μm and 90 μm. The grid width of the line grid shown in FIG. 6b and FIG. 6c is 80 μm.

FIG. 6d illustrates the effect of the perforated regions 10 of the carrier substrate 2 shown in FIG. 6b and FIG. 6c when the document 1 is viewed from the underside 5 of the carrier substrate 2. If the document 1 is viewed substantially perpendicular to a plane spanned by the carrier substrate 2, the decorative ply 3 is visible in the regions 10 when the document 1 is viewed from the underside 5 of the carrier substrate 2. If the document 1 is tilted and viewed for example at its lateral viewing angle of more than 35°, preferably more than 25°, from the underside 5 of the carrier substrate 2, the decorative ply 3 is no longer visible. The decorative ply 3 is thus visible to an observer depending on a lateral viewing angle. If the decorative ply 3 is for example a color layer, a color change effect dependent on the viewing angle can hereby be generated in the regions 10 when the document 1 is viewed from the underside 5 of the carrier substrate 2.

FIG. 7a to FIG. 7c schematically show method steps for producing a document 1.

As shown in FIG. 7a, the carrier substrate 2 is provided first. With respect to the design of the carrier substrate 2, reference is made here to the above statements. In a next step, as shown in FIG. 7b, the decorative ply 3 is applied to the upper side of the carrier substrate 2. The decorative ply 3 is for example a layer with color pigments which generate a green color impression. With respect to further possible designs of the decorative ply 3, reference is made here to the above statements. The application of the decorative ply 3 here is preferably effected by means of hot-stamping, cold-stamping or laminating, i.e. the decorative ply can be for example a transfer ply of a hot-stamping film, which is applied to the carrier substrate 2 by means of hot-stamping, and/or a laminating film, which is applied to the carrier substrate 2 by means of hot-gluing. In a further step, the carrier substrate 2 is then perforated in the region by means of a laser. This makes it possible for the decorative ply 3 to be visible when the document 1 is viewed from the underside 5 of the carrier substrate 2. In FIG. 7c the carrier substrate 2 is perforated completely by means of a laser. However, it is also possible for the carrier substrate 2 not to be perforated completely and for the decorative ply 3 still to be visible when the document 1 is viewed from the underside 5 of the carrier substrate 2. Thus, the carrier substrate can comprise for example a transparent plastic ply, which is arranged between the upper side 4 of the carrier substrate 2 and the decorative ply 3 and therefore, because of its transparency, does not impair the visibility of the decorative ply 3 when the document 1 is viewed from the underside 5 of the carrier substrate 2. In FIG. 7c the perforation of the carrier substrate 2 is effected from the direction of the underside 5 of the carrier substrate 2.

By perforation is meant here the complete removal here of the carrier substrate 2. The perforation here is preferably effected on the basis of laser cutting and/or laser ablation, with the result that the carrier substrate 2 is worn away and/or ablated and/or burnt up and/or evaporated residue-free in the region 10. A gas laser, in particular a CO₂ laser, was used to perforate the carrier substrate 2 according to the embodiment example of FIG. 7c. The laser power here is advantageously at least 250 W, preferably at least 300 W, further preferably at least 350 W. It is further advantageous if the wavelength of the laser is between 9.35 μm and 10.25 μm. The region 10 of the carrier substrate 2 in FIG. 7c was perforated by means of a CO₂ laser with a laser power of 300 W and a wavelength of 10.6 μm.

The laser beam here is preferably deflected along and/or onto the region 10 of the carrier substrate by means of moveable mirrors, in particular by means of a laser scanning module.

The beam diameter of the laser in the focal point here is at least 20 μm, preferably at least 50 μm, particularly preferably at least 100 μm. However, it is also possible to widen the laser beam by means of a lens system such that the beam diameter in the focal point is at most 2 mm, preferably at most 1 mm. The region 10 shown in FIG. 7c was generated by means of a laser beam which has a beam diameter of 200 μm in the focal point, with the result that the width of the region 10 is likewise essentially 200 μm.

The laser here is preferably further operated at a writing speed of 3000 mm/s, preferably of 2200 mm/s, further preferably of 2000 mm/s. It is further possible for the laser to have a writing surface area of 200×200 mm, preferably of 150×150 mm, further preferably of 140×140 mm.

The carrier substrate 2 here is expediently transported at a running speed of 200 m/min, preferably of at most 130 m/min, further preferably of 120 m/min, still further preferably of 60 m/min. It is hereby ensured that the carrier substrate 2 is perforated or removed residue-free in the region 10 depending on the writing surface area of the laser, the writing speed of the laser and/or the laser power.

FIG. 8a to FIG. 8c schematically show method steps for producing a document 1.

As shown in FIG. 8a, the carrier substrate 2 is provided in a first step. With respect to the design of the carrier substrate 2, reference is made here to the above statements.

The decorative ply 3 is applied to the carrier substrate 2 in a further step according to FIG. 8b. The application is preferably effected here by means of hot-stamping. The decorative ply shown in FIG. 8b here comprises the layers 20, 21, 22 and 23. The layer 22 is a hot-glue layer, which comprises in particular acrylates, PVC, polyurethane or polyester and by means of which the decorative ply 3 is firmly applied to the upper side 4 of the carrier substrate 2. The layer 20 is a color layer which has a blue color shade. The layer 21 is likewise a color layer, but which has a yellow color shade. Such color layers can be generated for example by layers which are provided with the corresponding color pigments and/or dissolved dyes. However, it is also possible for the layers and 21 to be for example layers which in each case generate a different optically variable effect. Thus, it is possible for example for the layers 20 and 21 to have differently formed microstructures which in each case generate an optically variable effect. The layer 23 is a protective varnish layer. With respect to the design of the layer 23, reference is made here to the above statements.

It is further advantageous if the step of applying the decorative ply 3 to the upper side 4 of the carrier substrate 2 further comprises the following step:—stretching the decorative ply 3 before application of the decorative ply 3 to the carrier substrate 2, wherein the stretching of the decorative ply 3 is between 0% and 10%, preferably between 0% and 5%. Here, the stretching of the decorative ply is preferably generated by a stretching of the transfer film or the laminating film which comprises the decorative ply 3 as transfer ply. Through a corresponding stretching, a motif spacing of motifs located on the decorative ply 3 is made to match the spacings of security features located on the carrier substrate 2. Values for the tolerance between the decorative ply 3, in particular between motifs located on the decorative ply 3, and the perforations in regions 10 and 11 of between ±0.1 mm and ±2.0 mm, preferably between ±0.3 mm and ±1.5 mm, can hereby be achieved.

After the decorative ply 3 has been applied, the carrier substrate 2 and the layer 22 of the decorative ply 3 are, as shown in FIG. 8c, perforated in the region 10 by means of a laser. The blue color layer 20 is hereby uncovered, with the result that a blue color impression is perceived in the region 10 when the document 1 is viewed from the underside 5 of the carrier substrate 2. If the region, as shown above for example in FIG. 3a, is designed linear and forms a pattern, the linear pattern appears blue to an observer. Further, as shown in FIG. 8c, the carrier substrate 2 and the layers 22 and 20 of the decorative ply 3 are perforated by means of a laser in the region 11. The yellow color layer 21 is hereby uncovered, with the result that a yellow color impression is perceived in the region 10 when the document 1 is viewed from the underside 5 of the carrier substrate 2. It is possible here for the region 10 and the region 11 to be connected and/or for the regions 10 and 11 to overlap at least in regions. This makes it possible for example to uncover multi-colored motifs in a targeted manner from the underside 5 of the carrier substrate 2, wherein the chromaticity and the optical impression of these motifs are defined by the uncovered layers 20 and 21 decorative ply 3.

It is also possible here to generate the regions 10 and 11 by means of different lasers. Thus, at least two lasers are used, which are preferably matched to each other such that the production process can be shortened.

After the perforation of the carrier substrate 2 and the layers 22 and 20 in the regions 10 and 11, it is possible for the method further to comprise the following step:—applying one or more, in particular transparent, plastic plies, which are applied in particular to the upper side and/or underside of the carrier substrate 2. The stability or robustness of the document 1 against environmental influences can hereby be further improved. The perforated regions 10 and 11 can also be sealed hereby on the underside 5 of the carrier substrate 2, in order to prevent ingress of impurities.

It is also possible for the step of applying the decorative ply 3 and/or the step of perforating the carrier substrate 2 and the layers 22 and 20 further to comprise the following steps:
detecting the positional data of a security feature of the carrier substrate 2, in particular a watermark;
optionally correcting the detected positional data by means of an algorithm to form corrected positional data;
introducing the control openings into the carrier substrate 2 on the basis of the detected positional data, in particular on the basis of the corrected positional data, in particular by means of a laser.

FIG. 9a and FIG. 9b schematically show devices 19 for carrying out the method.

FIG. 9a schematically shows a device 19 for carrying out the method.

The device 19 here has the application device 31a, by means of which a decorative ply is applied to the carrier substrate 3. The device 19 further comprises a laser for perforating at least one layer of the carrier substrate 2, and a transport device 30, which serves to transport the carrier substrate 2. Thus, it is possible for example for the transport device to comprise a storage roll, on which the carrier substrate 2 is wound. Alternatively, it is also possible for the transport direction to be designed for transporting the carrier substrate 2 in sheet form.

The laser 32 is preferably a gas laser, in particular a CO₂ laser, and/or a solid-state laser, in particular an Nd:YAG laser. The laser power is advantageously at least 250 W, preferably at least 300 W, further preferably at least 350 W. It is further advantageous if the wavelength of the laser 32 is between 9.35 μm and 10.25 μm. Thus, for example, a CO₂ laser with a laser power of 300 W and a wavelength of 10.6 μm can be used. The laser 32 preferably has a writing speed of 3000 mm/s, preferably of 2200 mm/s, further preferably of 2000 mm/s.

It is further possible for the laser 32 to have a writing surface area of 200×200 mm, preferably of 150×150 mm, further preferably of 140×140 mm.

The transport device 30 is expediently designed such that the carrier substrate 2 is transported at a running speed of 200 m/min, preferably of 130 m/min, further preferably of 120 m/min, still further preferably of 60 m/min.

FIG. 9b schematically shows a device 19 for carrying out the method, comprising a transport device 30, a sensor unit 33, a computer unit 34, a printing unit 35 and a stamping unit 36.

The carrier substrate 2 is first fed to the sensor unit 33 by the transport unit 30. The sensor unit 33, in particular an optical sensor unit for detecting radiation in reflected light and/or in transmitted light in one or more visible wavelength ranges or the entire visible wavelength range and/or in one or more ultraviolet wavelength ranges or the entire ultraviolet wavelength range and/or in one or more infrared wavelength ranges or the entire infrared wavelength range, is for example a photodetector, a CCD sensor or a CMOS camera, and makes it possible to detect the position of the at least one security feature of the carrier substrate 2, in particular a watermark and/or a printed feature. The detected position of the security feature is transmitted to a computer unit 34, which determines corrected positional data from the detected positional data by means of an algorithm. The position of the carrier substrate 2 can be matched to the corrected positional data by means of an actuator, not represented. The actuator can thus correct the location of the carrier substrate 2 in the plane relative to the positions of the subsequent units, in particular the stamping unit 36 and/or the laser 32, to generate control openings.

The carrier substrate 2 is then transported into the stamping unit 36, by means of which, after successful location correction, control openings and/or window openings which are extensive in relation to the perforations generated by means of the laser 32 can be introduced into the carrier substrate, as already explained above. It is also possible for the introduction of control openings to be effected by means of a laser.

The carrier substrate 2 is then fed to the application device 31a, by means of which a decorative ply is applied to the carrier substrate 2. Here too, the location of the carrier substrate 2 can be adapted using the corrected positional data. The carrier substrate 2 is then fed to the laser 32 for the perforation of at least one layer of the carrier substrate 2. With respect to the design of the laser 32, reference is made here to the above statements.

The carrier substrate 2 is then fed to the application device 31b, by means of which a transparent plastic ply is applied to the underside of the carrier substrate 2. The regions perforated by means of the laser 32 and/or the window openings introduced by the stamping unit 36 can hereby, as stated above, be sealed. Here too, it is possible to adapt the location of the carrier substrate 2 using the corrected positional data.

Finally, the carrier substrate 2 is fed to the printing unit 35, in order to print for example colored patterns and/or alphanumeric characters on the carrier substrate 2. Here too, it is possible to adapt the location of the carrier substrate 2 using the corrected positional data.

Further machining units can follow, such as for example at least one further printing unit, at least one further application device and/or at least one vapor-deposition device and/or at least one moistening unit, etc., which are not shown here, however. Finally, the carrier substrate 2 can also be fed to a cutting unit, in order to divide the carrier substrate 2 into individual panels.

### LIST OF REFERENCE NUMBERS

1 document
2 carrier substrate
3 decorative ply
4 upper side
5 underside
6 paper ply
7 plastic ply
8 opaque layer
9 observer
10, 11, 12, 13 regions
19 device
20 first layer
21 second layer
22 adhesion layer
23 protective varnish layer
30 transport device
31a, 31b application devices
32 laser
33 sensor unit
34 computer unit
35 printing unit
36 stamping unit
40, 41 sections
50 line width

1. A document comprising a carrier substrate and a decorative ply, wherein the carrier substrate has an upper side and an underside, and the decorative ply is applied to the upper side of the carrier substrate, and wherein at least one layer of the carrier substrate is perforated in one or more first regions by means of a laser such that the decorative ply is visible in the one or more first regions when the document is viewed from the underside of the carrier substrate.

2. The document according to claim 1, wherein
the carrier substrate is a paper substrate, and/or wherein the carrier substrate comprises cotton fibers, wood fibers, pulp fibers, textile fibers and/or plastic fibers.

3. The document according to claim 1, wherein
the carrier substrate comprises one or more, transparent, plastic plies, which are arranged on the upper side and/or underside of the carrier substrate, wherein at least the one or more, transparent, plastic plies arranged on the underside of the carrier substrate are perforated in the one or more first regions by means of the laser.

4. (canceled)

5. (canceled)

6. The document according to claim 1, wherein
the carrier substrate has a layer thickness between 30 μm and 250 μm.

7. The document according to claim 1, wherein
at least one layer of the carrier substrate is perforated in one or more second regions by means of the laser such that the decorative ply is visible in the one or more second regions when the document is viewed from the underside of the carrier substrate wherein the one or more second regions have a different pattern from the one or more first regions and/or a different contour and/or a different code.

8. The document according to claim 1, wherein
each of the one or more first and/or second regions lies within a predefined region of surface, wherein each of the one or mote first and/or second regions comprises at most 25%, of the surface area of the respective predefined region of surface when viewed perpendicular to a plane spanned by the carrier substrate.

9. The document according to claim 1, wherein
the line width and/or the diameter of the one or more first regions and/or second regions is at most 2 mm, when viewed perpendicular to a plane spanned by the carrier substrate.

10. The document according to claim 1, wherein
the line width and/or the diameter of the one or more first regions and/or second regions when viewed perpendicular to a plane spanned by the carrier substrate is chosen such that the decorative ply is visible to the human eye in the one or more first regions and/or second regions when the document is viewed from the underside of the carrier substrate and/or wherein the line width and/or the diameter of the one or more first regions and/or second regions is at least 20 μm, when viewed perpendicular to a plane spanned by the carrier substrate.

11. The document according to claim 7, wherein,
in regions comprising the decorative ply, the document provides a first optically variable effect, which in reflected light can be detected by a sensor unit and/or is visible to the human eye, and/or wherein, in regions comprising the decorative ply, the document has at least one first transmittance, which in transmitted light can be detected by a sensor unit (33) and/or is visible to the human eye, and in regions comprising the carrier film and the decorative layer has at least one second transmittance, which in transmitted light can be detected by a sensor unit and/or is visible to the human eye, wherein the at least one first transmittance and the at least one second transmittance differ from each other or match at least partially or completely.

12. (canceled)

13. The document according to claim 1, wherein
at least one of the third regions of the carrier substrate is cut out by means of stamping and/or by means of a laser, such that the decorative ply is visible in the at least one third region when the document is viewed from the underside of the carrier substrate wherein the at least one third region has a surface area at least 4 times, larger than the one or more first and/or second regions.

14. (canceled)

15. The document according to claim 1, where
the one or more first and/or second regions are designed patterned, as a graphic motif, alphanumeric, linear, punctiform and/or as machine-readable code.

16. The document according to claim 1, wherein
the one or more first regions are arranged in a line grid.

17. The document according to claim 16, wherein
the grid width of the line grid corresponds substantially to the layer thickness of the carrier substrate and/or wherein the grid width of the line grid is between 30 μm and 250 μm.

18. (canceled)

19. (canceled)

20. The document according to claim 1, wherein
the decorative ply has a first layer and a second layer and the first layer is arranged between the upper side of the carrier substrate and the second layer wherein the first and second layers are selected from the group consisting of one or more color layers, one or more layers with optically variable pigments, one or more thin-film layer systems, one or more layers generating an optically variable effect, one or more layers with color pigments and/or dissolved dyes and/or one or more layers with microstructures, wherein the layers generate at least one color effect in the wavelength range of from 400 nm to 800 nm, when the document is viewed from the underside of the carrier substrate.

21. (canceled)

22. (canceled)

23. The document according to claim 7, wherein
the decorative ply has a first layer and a second layer and the first layer is arranged between the upper side of the carrier substrate and the second layer, wherein the first and second layers are selected from the group consisting of one or more color layers, one or more layers with optically variable pigments, one or more thin-film layer systems, one or more layers generating an optically variable effect, one or more layers with color pigments and/or dissolved dyes and/or one or more layers with microstructures, wherein the layers generate at least one color effect in the wavelength range of from 400 nm to 800 nm, when the document is viewed from the underside of the carrier substrate and wherein
the at least one layer of the carrier substrate is perforated in the one or more first regions by means of a laser such that the first layer is visible in the one or more first regions when the document is viewed from the underside of the carrier substrate, and wherein the at least one layer of the carrier substrate and the first layer of the decorative ply is perforated in the one or more second regions by means of a laser such that the second layer is visible in the one or more second regions when the document is viewed from the underside of the carrier substrate.

24. The document according to claim 1, wherein
the carrier substrate is completely perforated in the one or more first and/or second regions.

25. The document according to claim 1, wherein
the decorative ply is transparent at least in regions.

26. The document according to claim 1, wherein
the values for the tolerance between the decorative ply and the perforations in the one or more first and/or second regions and/or the at least one third region are between ±0.1 mm and ±2.0 mm.

27. A method for producing a document according to claim 1, comprising a carrier substrate with an upper side and an underside, wherein the method comprises the following steps a), b), c), which are performed in the sequence a), b), c) or a), c), b):
a) providing the carrier substrate;
b) applying a decorative ply by means of hot-stamping, cold-stamping or laminating, to the upper side of the carrier substrate;
c) perforating at least one layer of the carrier substrate in one or more first regions by means of a laser such that the applied decorative ply is visible in the one or more first regions when the document is viewed from the underside of the carrier substrate.

28. The method according to claim 27, wherein
the method further comprises the following step, which is carried out before step b):
d) perforating at least one layer of the carrier substrate in one or more second regions by means of a laser such that the decorative ply is visible in the one or more second regions when the document is viewed from the underside of the carrier substrate.

29. The method according to claim 27, wherein
the method further comprises the following step, which is carried out before step b):
e) cutting out at least one third region of the carrier substrate by means of stamping and/or by means of a laser, such that the decorative ply is visible in the at least one third region when the document is viewed from the underside of the carrier substrate.

30. The method according to claim 27, wherein,
in step b), the decorative ply is applied such that the decorative ply completely covers the one or more first and/or second regions when viewed perpendicular to a plane spanned by the carrier substrate.

31.-43. (canceled)

44. A device for carrying out a method according to claim 27, the device
a transport device for transporting the carrier substrate;
a first application device for applying the decorative ply to the single- or multi-layered carrier substrate;
a first unit comprising a laser for perforating at least one layer of the carrier substrate in one or more first regions.

45. (canceled)

46. (canceled)
